(19) United States
(12) Patent Application Publication
(10) Pub. No.: US 2021/0402721 A1
(43) Pub. Date: Dec. 30, 2021

(54) SILICONE FRESNEL LENSES ON GLASS SUBSTRATES FOR SOLAR CONCENTRATORS AND METHOD OF MANUFACTURING

(71) Applicant: HELIAC APS, Hørsholm (DK)

(72) Inventors: Henrik Pranov, Hørsholm (DK); Maria Matschuk, Espergaerde (DK)

(21) Appl. No.: 17/311,881

(22) PCT Filed: Dec. 11, 2019
(86) PCT No.: PCT/EP2019/084765

§ 371 Date: Jun. 8, 2021

(30) Foreign Application Priority Data
Dec. 12, 2018 (GB) 1820275.4

(51) Int. Cl. B29D 11/00; C03C 17/30; G02B 19/00; G02B 3/08; F24S 23/30

(52) U.S. Cl. CPC B29D 11/00269; C03C 17/30; G02B 19/0038; B29K 2083/00; G02B 3/08; F24S 23/31; C03C 2218/32; G02B 19/0009

(57) ABSTRACT

A method of manufacture of an optical element for focusing electromagnetic radiation, comprising the steps of:•(a) providing a first light-transmissive glass substrate (20) having a front surface on which the electromagnetic radiation is incident in use and a back surface opposite to the front surface;•(b) applying a liquid silicone resin (30) to the back and/or the front surface of the glass substrate;•(c) contacting the liquid silicone resin with a mould such that the liquid silicone resin adopts the form of the mould and forms microstructures extending over the surface(s) of the glass substrate to which the liquid silicone resin has been applied;•(d) curing the liquid silicone resin to form a microstructured light-transmissive silicone coating wherein the glass surface has been

C roughened before application of the silicone.

### FIELD OF THE INVENTION

The present invention relates to coatings for glass, particularly for optical elements such as for use in solar concentrators, and to the adhesion of those coatings to the glass. In particular, the coatings are structured coatings having optical effects. The invention further relates to methods of making the coated glass, a solar concentrator comprising the coated glass as an optical element, a method of manufacture of a solar concentrator, and a method of manufacture of a mould suitable for producing structured coatings having optical effects.

### BACKGROUND OF THE INVENTION

In many applications, concentrators or lenses are used to focus light. Many types of lenses have been demonstrated, such as classical refractive lenses, concave reflective lenses and Fresnel lenses. In the field of solar energy collection, Fresnel and similar lenses have been described. These lenses can be used to focus light by reflection (and optionally also refraction) to a focal point, line or area at the front (light incident) side of the lens, or by refraction of light passing through the lens to a focal point, line or area at the back surface of the lens. The construction of such lenses can be divided broadly into two groups: those where the lens structures and reflective layers are provided on a front (light incident) side of a substrate which need not be light transmissive, resulting in a reflective lens; and those in which the substrate must be light transmissive, and lens structures may be provided on the front and/or the back surface of the light transmissive substrate. Where a reflective layer is provided on the back face of the lens, a reflective lens results; where no reflective layer is provided the result is a refractive lens. The present invention is concerned with lenses requiring a light transmissive substrate.

U.S. Pat. No. 4,315,671 describes a lens for concentration of electromagnetic radiation combining reflective and refractive properties. In one embodiment, the lens has a substantially planar front (light-incident) surface and inclined regions on the back surface having a mirror coating thereon. This allows direction of the reflected light by both the reflection angle imposed by the reflective inclined back surface of the lens and the refraction that takes place as a result of the passage of the reflected light through the body of the lens. The avoidance of the use of mirror coated inclined surfaces on the front surface of the lens is said to make cleaning the lens easier.

WO2015/081961 describes an optical element for use in a linear solar concentrator, which element comprises a light transmissive polymer foil with a Fresnel lens mirror structure on the back surface and, optionally, an antireflective layer on the front surface, which element allows light incident normal to the plane of the front surface of the polymer foil to be reflected and then refracted to be directed transversely to the plane of the element, so that a flat element may be used instead of a parabolic element. The optical element can be manufactured using roll-to-roll processes. The optical element is intended, in use, to be mounted to the front surface (ie the side on which light is incident) of a substrate forming part of the solar concentrator.

U.S. Pat. No. 4,385,430 describes a system useful for concentrating solar energy, in which Fresnel reflector elements are formed in plastic materials by casting, moulding, extruding or embossing processes, followed by metallization of the grooved surface by methods such as vacuum deposition. Acrylic Fresnel strips are particularly mentioned. In order to prevent environmental damage to the plastics materials from which the Fresnel reflector elements are formed, it is suggested that a glass layer should be bonded by adhesive to the front (light-incident) side of the Fresnel reflector. The back face of the Fresnel reflector is adhered to a substrate such as an aluminium sheet to reduce assembly cost while maintaining the required rigidity.

WO2017/149095 describes an optical element for concentrating solar irradiation, a focusing polymer foil for use in an optical element, a method of manufacture of the foil and of the element, and a method of repairing an optical element. The optical element described therein addresses the need to renew the efficiency of an optical element after a period of use, once the efficiency has been deteriorated as a result of UV damage and/or scratching of the element by windborne dust or washing of the element. A focusing polymer foil comprising a switchable adhesive layer is provided that can be removed from the substrate and replaced with a new focusing polymer foil once the performance of the initial foil is degraded by exposure to the environment. Arrangements of lenses in which the lens structures, and optionally also a reflective layer, are provided on the back surface of a light transmissive substrate are described.

Rumyantsev, in Optics Express 2010, 18, S1, A17-A24, describes the use of solar concentrator modules comprising silicone on glass Fresnel lens panels, in which a silicate glass sheet is used as a superstrate for transparent silicone with Fresnel microprisms formed therein by polymerization of a silicone compound directly on the glass sheet with the use of a negatively profiled mould. It is taught therein that this has the advantages of high UV stability of silicone, excellent resistance to thermal shocks and high and low temperatures, good adhesive properties in a stack with silicate glass, and lower absorption of sunlight in comparison with acrylic Fresnel lenses of a regular thickness. The lenses are on a small scale, 40×40 mm, used with a 1.7 mm diameter receiver.

EP2871499 describes the formation of an optical element for use in a concentrating photovoltaic device, which comprises a glass substrate, and a sheet-like moulded body made of an organic resin and including a Fresnel lens pattern formed therein bonded to the face of the glass substrate facing away from the incident light. The use of silicone for the sheet-like moulded body is discussed, and it is taught that such resins have a thermal expansion coefficient that is very different from glass, which causes warping of the optical element as a result of changing temperature. Accordingly, the document teaches the use of an acrylic block co-polymer and acrylic resin combination as the sheet-like moulded body.

CN102096125 discloses a manufacturing method and device of a light-focusing Fresnel lens in which a coating is sprayed on to a clean ultrawhite glass substrate, followed by shaping of the coating by pressing a structured die-pressing roller thereon to provide Fresnel lens structures in the coating. The sprayed coating can be a silicone glue. The use of the roller mould is said to maintain a small contact area between the mould and the coating layer during the moulding process.

WO2011/021694 describes reduction of the focal length of Fresnel lenses by replacement of a resin Fresnel structure layer with a glass Fresnel structure layer formed directly from a glass substrate or integrally with a glass substrate from a glass frit and binder combination which is fired in situ to form the glass lens.

US2015/0110970 describes a method of applying a silicone Fresnel layer to a glass substrate by a casting method carried out in an open casting mould into which the glass substrate, provided with an adhesion promoter layer, is inserted and which is filled with a silicone precursor. The assembly is then subjected to conditions that result in curing of the silicone precursor.

EP2603822 discloses, amongst other arrangements, a silicone structured layer on a glass substrate for an optical element. The document aims to allow for thermal deformation due to thermal expansion of the structured layer by predicting that deformation and constructing the structured layer in such a way that it will have the desired geometry at the expected operating temperature.

### SUMMARY OF THE INVENTION

It has been recognized by the present inventors that, while providing a glass layer on the front surface of Fresnel reflector elements formed from plastics may provide some protection for the Fresnel elements from UV light, that does not provide the desired lifetime for the optical element. While providing replaceable focusing films as described in WO2017/149095 allows the lifetime of an optical element to be extended, it would also be desirable to provide optical elements for which the lifetime may be expected to be of the order of 25 to 30 years, or even longer, without the need to replace a focusing film.

Further, it is desirable to be able to provide an optical element having a size that is practical for use in commercial solar concentrators, and/or that provides flexibility in the arrangement of the layers comprised in the optical element.

Accordingly, in a first aspect, the present invention provides a method of manufacture of an optical element for focusing electromagnetic radiation, comprising the steps of:
(a) providing a first light-transmissive glass substrate having a front surface on which the electromagnetic radiation is incident in use and a back surface opposite to the front surface;
(b) applying a liquid silicone resin to the back and/or the front surface of the glass substrate;
(c) contacting the liquid silicone resin with a mould such that the liquid silicone resin adopts the form of the mould and forms microstructures extending over the surface(s) of the glass substrate to which the liquid silicone resin has been applied;
(d) curing the liquid silicone resin to form a microstructured light-transmissive silicone coating;
   wherein the surface(s) of the glass substrate to which the liquid silicone resin is to be applied is/are roughened.

Preferably, the mould has a form that causes, in step (c), the liquid silicone resin to adopt the form of microstructures that focus the electromagnetic radiation incident on the optical element in use, more preferably Fresnel lens microstructures.

Preferably, the surface roughness of the surface(s) of the glass substrate to which the liquid silicone resin is to be applied is in the form of nanostructures having a height of less than 1000 nm, preferably up to 800 nm, more preferably up to 600 nm, such as up to 500 nm, more preferably up to 400 nm, most preferably up to 300 nm. Preferably, the nanostructures have a height of 50 nm or more, preferably 100 nm or more, most preferably 200 nm or more. Preferably, the R_{z} value for the roughened surface is within the range of from 50 nm to 800 nm, more preferably from 100 nm to 600 nm, most preferably from 200 nm to 400 nm. Preferably, the structures have a width that is the same as their height. Suitable surface roughening can be provided by a refractive index gradient structure etched on the glass substrate.

Preferably, following step (a) and before step (b) the method further comprises the step of forming nanostructures on the surface(s) of the glass substrate to which the liquid silicone resin is to be applied. Preferably, the surface roughness of the surface(s) of the glass substrate to which the liquid silicone resin is to be applied is in the form of nanostructures having a height of less than 1000 nm, preferably up to 800 nm, more preferably up to 600 nm, such as up to 500 nm, more preferably up to 400 nm, and most preferably up to 300 nm. Preferably, the nanostructures have a height of 50 nm or more, preferably 100 nm or more, most preferably 200 nm or more. Preferably, the nanostructuring step comprises etching a refractive index gradient structure on the surface(s) of the glass substrate to which the liquid silicone resin is to be applied, preferably such that a porous structure or an open structure is etched into the surface of the substrate. Suitably, the etching is a plasma etching step.

Preferably, where only one of the surfaces of the glass substrate is to be coated with liquid silicone resin, the other surface of the glass substrate is provided with an antireflective coating or treatment. Suitably, following step (a) and before step (b), the method further comprises the step of applying an antireflective coating or antireflective treatment to this surface of the glass substrate.

Preferably, the glass substrate has a size of at least 0.5 m in width and/or length, where the front and back surface of the substrate have a quadrilateral form. Preferably, the glass substrate has a minimum front surface area of 0.25 m². Preferably, the glass substrate has a width and/or length of at least 0.75 m. Preferably, the glass substrate has a minimum front surface area of 0.5625 m². Preferably, the glass substrate has a width and/or length of at least 1 m. Preferably, the glass substrate has a minimum front surface area of 1 m². For a substrate of 1 m×1 m width and length, a suitable thickness would be from 2 mm to 5 mm, such as 3 mm. Suitably, the glass substrate has a maximum area of 4 m², such as a width of 2 m and a length of 2 m. For a substrate of 2 m×2 m width and length, a suitable thickness would be from 6 mm to 10 mm, such as 8 mm.

Preferably, the glass substrate is planar, within manufacturing tolerances; a deviation from non-planarity of 0.5 to 5 degrees is acceptable in use in a solar concentrator.

Suitably, in step (b), the application of the liquid silicone resin is carried out by any suitable method known in the art for providing a layer of a liquid on a surface. For example, spin coating (if the substrate size allows) or knife coating can be used. Preferably, however, one or more droplets, pools or areas of liquid silicone resin is applied to the surface without any active spreading of the one or more droplets, pools or areas into a continuous layer during the application step (b).

Suitably, in step (c), the mould may take any suitable form or be made of any suitable material capable of forming the liquid silicone resin into microstructures extending over the chosen surface(s) of the glass substrate. For example, the mould may be a stamp or a structured roller. The mould may be of plastics material, metal, glass or ceramic, and may be flexible or rigid.

Preferably, the mould is a thermoplastic film, one surface of which has formed thereon microstructures that are the inverse of the microstructures that, when adopted by the liquid silicone resin, focus the electromagnetic radiation incident on the optical element in use. Preferably, the thermoplastic film is flexible, for example such that it may be peeled from the surface of the silicone coating after curing. Particularly preferably, the thermoplastic film may be selected from polypropylene film and polyethylene film. Preferably, the thickness of the thermoplastic film may be from 40 μm to 200 μm. Preferably, the thermoplastic film has a width and length that is greater than or equal to that of the glass substrate used. Preferably, the mould further comprises a carrier foil on which the thermoplastic film is supported.

Preferably, in step (c), the contacting of the liquid silicone resin with the mould comprises pressing the thermoplastic film surface on which the microstructures are formed against the liquid silicone resin in order that the liquid silicone resin adopts the form of the microstructures. Preferably, pressing the thermoplastic film against the liquid silicone resin is carried out using a roller. Preferably, the pressing of the thermoplastic film against the liquid silicone resin also spreads the liquid silicone resin, particularly where the liquid silicone resin was applied in step (b) as one or more droplets, pools or areas of liquid silicone resin on the surface of the substrate, to form a continuous coating extending over the chosen surface(s) of the glass substrate.

Preferably, in step (d), the curing is carried out using a combination of temperature and time. For example, depending on the selected liquid silicone resin, the curing conditions may be 24 hours at ambient temperature, such as at 20° C., 10 hours at 40° C., or 1 hour at 70° C. It will be understood by the skilled person that a balance between the temperature of curing and the time of curing can be found for a given resin depending on the process requirements; for example, the availability of suitable heating apparatus or the time available for curing. Preferably, the curing does not comprise the use of UV radiation to initiate the curing process.

Suitably, following the curing step (d), and where the mould is in the form of a stamp, a thermoplastic film, or other suitable form, the mould may be left in place on the cured light-transmissive silicone coating to act as a protective layer for the coating prior to its use as an optical element. This is particularly preferable where the mould is a thermoplastic film, or a thermoplastic film supported on a carrier foil, as described above.

Suitably, the method comprises the further step of:
(e) removing the mould from the microstructured light-transmissive silicone coating.

Preferably, the removal step (e), where the mould is a thermoplastic film as described above, comprises peeling of the thermoplastic film from the silicone coating.

In a second aspect of the invention, the present invention provides an optical element for focusing electromagnetic radiation, comprising:

a first light-transmissive glass substrate having a front surface on which the electromagnetic radiation is incident in use and a back surface opposite to the front surface; and
a light-transmissive silicone coating on the back and/or the front surface of the substrate;
wherein the silicone coating has formed thereon microstructures that focus the electromagnetic radiation incident on the optical element, and
wherein the surface(s) of the glass substrate on which the silicone coating is formed is/are roughened.

In the invention, no adhesive layer or coating of adhesion promoter is provided between the silicone coating and the glass substrate. This reduces the cost and complexity of manufacture, and avoids possible UV light or water ingress induced degradation of an adhesive layer.

Preferably, a protective film is provided on the structured side of the silicone coating, ie that side of the silicone coating that is not in contact with the glass substrate. Suitably, the protective film is a thermoplastic film. Suitably, the protective film has formed thereon microstructures that are the inverse of the microstructures formed on the silicone coating, and which cooperate with the microstructures on the silicone coating.

Preferably, the light-transmissive silicone coating is formed from an outdoor use silicone. Suitably, the light-transmissive silicone coating is formed from a liquid silicone resin that is suitable for casting. Preferably, the silicone is of a type selected from the group consisting of polymerized siloxanes or polysiloxanes. Preferably, the silicone is selected from the group consisting of polydimethylsiloxanes (PDMS).

Preferably, the surface roughness of the surface(s) of the glass substrate on which the light-transmissive silicone coating is formed is in the form of nanostructures having a height of less than 1000 nm, preferably up to 800 nm, more preferably up to 600 nm, such as up to 500 nm, more preferably up to 400 nm, most preferably up to 300 nm. Preferably, the nanostructures have a height of 50 nm or more, preferably 100 nm or more, most preferably 200 nm or more. Preferably, the R_{z} value for the roughened surface(s) is within the range of from 50 nm to 800 nm, more preferably from 100 nm to 600 nm, most preferably from 200 nm to 400 nm. Preferably, the structures have a width that is the same as their height. Suitable surface roughening can be provided by a refractive index gradient structure etched on the glass substrate. The surface roughness of a glass substrate that is not roughened according to the invention is typically less than 5 nm, for example having an Rₐ value of less than 5 nm.

Preferably, the aspect ratio of the nanostructures is from 0.5 to 1.

Preferably, where only one surface of the glass substrate is coated with a light-transmissive silicone coating, the other surface of the glass substrate is provided with an antireflective coating or treatment. Preferably, the antireflective treatment is a refractive index gradient structure etched on the glass substrate.

Preferably, the glass is selected from borosilicate glass, low-iron glass, iron-free glass or float glass. It is particularly preferable to use low-iron glass or iron-free glass as the transmission of light therethrough is higher, thus increasing the efficiency of the optical element.

Preferably, the glass substrate has a size of at least 0.5 m in width and/or length, where the front and back surface of the substrate have a quadrilateral form. Preferably, the glass substrate has a minimum front surface area of 0.25 m². Preferably, the glass substrate has a width and/or length of at least 0.75 m. Preferably, the glass substrate has a minimum front surface area of 0.5625 m². Preferably, the glass substrate has a width and/or length of at least 1 m. Preferably, the glass substrate has a minimum front surface area of 1 m². For a substrate of 1 m×1 m width and length, a suitable thickness would be from 2 mm to 5 mm, such as 3 mm. Suitably, the glass substrate has a maximum area of 4 m², such as a width of 2 m and a length of 2 m. For a substrate of 2 m×2 m width and length, a suitable thickness would be from 6 mm to 10 mm, such as 8 mm.

Preferably, the optical element is for focusing light, especially solar radiation. Preferably, the microstructures that focus the electromagnetic radiation incident on the optical element are Fresnel lens microstructures.

In certain embodiments of the invention it is preferred that the back surface of the glass substrate is coated with the light-transmissive silicone coating. However, in other embodiments, it is preferred that the front surface of the glass substrate is coated with the light-transmissive silicone coating instead of or in addition to the back surface.

Suitably, the optical element may comprise a second light transmissive glass substrate, which may be placed in front of or behind (with reference to the intended direction of incident light) the first light transmissive glass substrate. Preferably, where the first light transmissive glass substrate is provided with a light transmissive silicone coating on the back surface, the second light transmissive glass substrate is placed behind the first light transmissive glass substrate. Preferably, where the first light transmissive glass substrate is provided with a light transmissive silicone coating on the front surface, the second light transmissive glass substrate is placed in front of the first light transmissive glass substrate. The second light transmissive glass substrate may be placed in contact with the first light transmissive glass substrate, or with the light transmissive silicone coating on the first light transmissive glass substrate. Alternatively, suitable spacers may be provided between the substrates to maintain the desired spacing between them. In either case, a suitable sealant may be used to isolate the spaces between the first and second light transmissive glass substrates from the ambient environment. Suitably, a dry gas, such as a dry inert gas, can be provided between the first and second light transmissive glass substrates. Suitably, the second light transmissive glass substrate is formed of the same materials and has the same size as described above for the first light transmissive glass substrate; preferably the first and second light transmissive substrates are formed from the same materials and have the same dimensions. Suitably, the second light transmissive glass substrate may have an antireflective coating on its front and/or the back face, which antireflective coating is preferably as described above for the first light transmissive glass substrate. Suitably, the second light transmissive glass substrate may further comprise a light transmissive silicone coating having microstructures formed thereon on, on the front and/or the back face of the second light transmissive glass substrate; preferably, the light transmissive silicone coating is as described above for the first light transmissive glass substrate. In a preferred embodiment, where the first light transmissive glass substrate is provided with a light transmissive silicone coating on the back surface, the second light transmissive glass substrate is placed behind the first light transmissive glass substrate and is provided with a light transmissive silicone coating on the front surface.

In a third aspect, the present invention provides a solar concentrator comprising at least one optical element according to the second aspect of the invention.

Suitably, the solar concentrator may comprise more than one optical element according to the invention, such as an array of optical elements. Suitably, each optical element may focus incident radiation on to an associated focal area. Alternatively, each optical element may have Fresnel microstructures formed thereon such that all of the optical elements comprised in the solar concentrator together focus the incident radiation onto a common focal area. As a further alternative, a subset of the optical elements comprised in the solar concentrator may have Fresnel microstructures formed thereon such that the subset of the optical elements together focus the incident radiation onto a common focal area, and one or more such subsets may be provided in the solar concentrator.

Suitably, the solar concentrator further comprises one or more solar collectors, or receivers, positioned to receive the radiation passing through and focused by the optical elements. The one or more solar collectors are positioned within the or each focal area associated with each optical element or group of optical elements comprised in the solar concentrator. Suitably, the solar collectors may each be selected from photovoltaic cells or a heat exchanger arranged to be heated by the incident solar radiation and to transfer that heat to a heat transfer fluid. Suitably, where the solar collector is a photovoltaic cell, the solar concentrator further comprises wiring and circuitry suitable to transfer the electrical energy produced by the photovoltaic cell to a suitable consumer of, or storage medium for, electrical energy, such as a domestic electrical circuit or a battery. Suitably, where the solar collector is a heat exchanger, the solar collector further comprises conduits suitable to convey the heat transfer fluid to a consumer of heat energy or a storage medium for heat energy, such as a steam generator, or a heat sink.

Preferably, the solar concentrator further comprises a support for the one or more optical elements. Preferably, the support holds the one or more optical elements in a desired orientation. Where more than one optical element is comprised in the solar concentrator, preferably the support holds the plurality of optical elements in a desired relationship to one another. Suitably, the plurality of optical elements may be held in a planar array. Preferably, the support is arranged such that the area of the one or more optical elements through which radiation may be transmitted and focused is maximized; for example, at least 90% of the area of each of the one or more optical elements is available to transmit and focus incident radiation. Suitably, the support may comprise two or more supporting beams extending in a mutually parallel direction, for example with their longitudinal axes aligned and spaced at regular intervals, and preferably with their proximal ends being aligned with one another and their distal ends being aligned with one another, such that the two or more supporting beams define a quadrilateral plane, such as a rectangular or square plane.

Preferably, the solar concentrator further comprises a mount which allows the position of the one or more optical elements with respect to the incident radiation to be adjusted, preferably to allow the one or more optical elements to be placed such that the incident radiation is orthogonal to the plane of the one or more optical elements. Suitably the mount may comprise a swivel joint. Where a support is included in the solar concentrator, the mount is suitably fixed to the support and allows the position of the support to be adjusted. Preferably, the mount further comprises a solar tracker that acts to adjust the position of the one or more optical elements with respect to the incident radiation to maintain the incident radiation orthogonal (or as near as practically possible to orthogonal) to the plane of the one or more optical elements during a period of two or more hours, such as three or more hours, four or more hours, six or more hours, such as eight or more hours, such as 12 or more hours.

In a fourth aspect, the present invention provides a method of manufacture of a solar concentrator, comprising the steps of:
i) providing one or more optical elements for focusing solar radiation, the one or more optical elements comprising:
   a light-transmissive glass substrate having a front surface on which the electromagnetic radiation is incident in use and a back surface opposite to the front surface; and
   a light-transmissive silicone coating on the back and/or the front surface of the substrate;
   wherein the light-transmissive silicone coating has formed thereon microstructures that focus the solar radiation incident on the optical element in use, and
   wherein the surface(s) of the glass substrate on which the light-transmissive silicone coating is formed is/are roughened;
ii) arranging the one or more optical elements to focus solar radiation to one or more focal areas;
iii) placing a collector of solar energy at the or each focal area.

Preferably, the one or more optical elements are each according to the second aspect of the invention. Preferably, the solar concentrator is according to the third aspect of the invention. Preferably, the method further comprises manufacture of the one or more optical elements according to the first aspect of the invention. Where the optical element is manufactured according to the first aspect of the invention, the method preferably comprises step (e) of the method of the first aspect of the invention. Where the optical element according to the second aspect of the invention is used and comprises a protective film on the structured side of the light-transmissive silicone coating, the method preferably further comprises the step of removing the protective film prior to step ii).

In a fifth aspect, the present invention provides a method of manufacture of a mould for shaping a liquid silicone resin on a glass substrate, wherein the mould is a thermoplastic film, one surface of which has formed thereon microstructures that are the inverse of the microstructures that, when adopted by the silicone coating, focus the electromagnetic radiation incident on the optical element in use, the method comprising the steps of:
providing a rotating extrusion coating roller for a polymer extrusion coating process using a thermoplastic material, which extrusion coating roller has the microstructures formed on its surface;
maintaining the temperature of the rotating extrusion coating roller below the solidification temperature of the thermoplastic material;
moving a carrier foil between the rotating extrusion coating roller and a rotating counter pressure roller at a given velocity corresponding to the rotational velocity of the rotating extrusion coating roller
continuously applying a melt of the thermoplastic material between the moving carrier foil and the rotating extrusion coating roller, whereby said thermoplastic melt is solidified upon contact with said extrusion coating roller, thereby forming a solid microstructured thermoplastic coating on said carrier foil.

All of the features described may be used in combination in so far as they are not incompatible therewith.

### BRIEF DESCRIPTION OF THE DRAWINGS

FIG. 1 shows a schematic drawing of the optical element of the invention.

FIG. 2 shows the optical element of the invention in use.

FIG. 3 shows a schematic drawing of stages of the method of manufacture of the optical element of the invention.

FIG. 4 shows an alternative embodiment of the optical element of the invention.

FIG. 5 shows a further alternative embodiment of the optical element of the invention.

FIG. 6 shows a yet further alternative embodiment of the optical element of the invention.

FIG. 7 shows a yet further alternative embodiment of the optical element of the invention.

FIG. 8 shows a yet further alternative embodiment of the optical element of the invention.

FIG. 9 shows a schematic drawing of a solar concentrator according to the invention.

FIG. 10 shows a schematic drawing of a method of manufacture of a mould for shaping a liquid silicone resin on a surface.

### DESCRIPTION OF THE INVENTION

In the second aspect of the invention is provided an optical element for focusing electromagnetic radiation, comprising:

a first light-transmissive glass substrate having a front surface on which the electromagnetic radiation is incident in use and a back surface opposite to the front surface; and
a light-transmissive silicone coating on the back and/or the front surface of the substrate; wherein the light-transmissive silicone coating has formed thereon microstructures that focus the electromagnetic radiation incident on the optical element, and
wherein the surface(s) of the glass substrate on which the light-transmissive silicone coating is formed is/are roughened.

The electromagnetic radiation to be focused by the optical element is suitably solar radiation, preferably sunlight, especially the visible and infrared wavelengths of sunlight.

It is advantageous to use glass for the light transmissive substrate in the present invention due to its toughness and UV light stability. In addition, glass is a relatively scratch resistant material which can easily be washed to remove dirt and dust that may accumulate on the surface during use. For these reasons, it is advantageous in certain embodiments of the invention for the glass substrate to form the front (light-incident) face of the optical element in use. However, in other embodiments, it is preferred that the front surface of the glass substrate is coated with the light-transmissive silicone coating instead of or in addition to the back surface. It has surprisingly been found by the present inventors that the light-transmissive silicone coating is sufficiently resistant to the environmental conditions to which the front surface of the optical element is subject, such as to UV radiation, wind, rain and dust, and has sufficiently high adhesion to the glass substrate, that it is not obligatory for the front surface of the optical element to be glass, as it taught for example in Rumyantsev, which discloses the use of glass as a superstrate for a silicone Fresnel structured layer. In certain circumstances, it is particularly preferable for both surfaces of the glass substrate to be coated with the light-transmissive silicone coating as this greatly increases the deflection angle that can be achieved using the optical element, and thus greatly shortens the focal distance of the optical element, compared with a similar optical element having the light-transmissive silicone coating on only one of the surfaces of the glass substrate, while maintaining a lightweight, simple and low cost construction for the optical element. This embodiment is particularly preferred for use in environments where there is expected to be little abrasion caused to the optical element due to airborne particulates such as sand or earth.

The glass used for the light transmissive glass substrate may be any suitable glass that is able to transmit therethrough the electromagnetic radiation intended to be focused by the optical element. Preferably, the glass is selected to transmit at least 80%, more preferably at least 90%, such as 95%, more preferably 98% and most preferably at least 99% of the wavelengths of the radiation intended to be focused by the optical element. Suitable glasses may include borosilicate glass, low-iron glass, iron-free glass or float glass. The glass may be toughened or annealed. It is particularly preferable to use low-iron glass or iron-free glass as the transmission of light therethrough is higher, thus increasing the efficiency of the optical element.

The glass substrate can have any suitable dimensions having regard to the quantity of solar energy it is desired to collect, the location, the intended arrangement of optical elements, and the ease with which panels can be transported to the intended location. However, the present invention particularly relates to larger scale optical elements for use in commercial solar concentrations. Accordingly, preferably, the glass substrate has a size of at least 0.5 m in width and/or length, where the substrate has a quadrilateral form in terms of the front and back surface. Preferably, the glass substrate has a minimum front surface area of 0.25 m². Preferably, the glass substrate has a width and/or length of at least 0.75 m. Preferably, the glass substrate has a minimum front surface area of 0.5625 m². Preferably, the glass substrate has a width and/or length of at least 1 m. Preferably, the glass substrate has a minimum front surface area of 1 m². For a substrate of 1 m×1 m width and length, a suitable thickness would be from 2 mm to 5 mm, such as 3 mm. Suitably, the glass substrate has a maximum area of 4 m², such as a width of 2 m and a length of 2 m. For a substrate of 2 m×2 m width and length, a suitable thickness would be from 6 mm to 10 mm, such as 8 mm. A typical lens would have dimensions of 1000-2000 mm width/height, and in this case the thickness would be between 3 mm and 8 mm to be stable under its own weight and wind pressure. Preferably, the glass substrate has the dimensions 1500 mm×1500 mm, in order that the mould for the microstructures can be made to the required dimensions according to the method of the fifth aspect of the invention.

Preferably, where only one of the front and back surfaces of the glass substrate are provided with a light-transmissive silicone coating, the other surface can be provided with an antireflective treatment, in order to maximize the amount of the incident light that is focused on to the desired object by the optical element when in use. Several types of antireflective treatments are known in the art. For the purposes of the present invention, antireflective treatments that also permit high transmission of electromagnetic radiation therethrough are required to obtain efficient solar concentration. Index-matching antireflective treatments or coatings have a refractive index intermediate between that of air and glass (in the context of the present invention) and so each interface exhibits less reflection than the air-glass interface. Graded-index (GRIN) antireflective treatments or coatings have nearly continuously varying refractive index, which allows reflection to be reduced for a wide range of frequencies of incident light and a wide range of angles of incidence. Single layer interference coatings use a single thin layer of transmissive material having a refractive index equal to the square root of the refractive index of the substrate, which theoretically results in zero reflectance for light having a wavelength equal to four times the thickness of the coating. For glass, the usual materials used for a single layer interference coating are MgF₂ or fluoropolymers. Multi-layer interference coatings use alternating layers of high and low refractive index materials. Moth eye antireflective treatments or coatings are based on the natural nanostructured coatings on moths' eyes, which are hexagonal patterns of bumps each about 200 nm high and spaced on 300 nm centres. As the bumps are smaller than the wavelength of the incident light, the light interprets the surface as having a continuous refractive index gradient between the air and the substrate, effectively removing the air-substrate interface. Moth-eye structures can be grown from tungsten oxide spheroids of several hundred nm size coated with a few nm of iron oxide.

Absorbing antireflective treatments or coatings are not appropriate for the present invention as absorbance of light reduces the efficiency of the optical element especially in the context of solar concentrators, where it is the aim to maximize the amount of light that is focused on to the focal area. Similarly, circular polarizers reduce the transmitted light by around 50% if the incident light is not polarized, and accordingly are not appropriate for the present invention.

The microstructured light-transmissive silicone coating used in the optical element of the present invention is found to be advantageous as silicones may have high UV transmissibility, as well as high transmissibility of visible and infrared light. Accordingly, the optical element can function efficiently to focus electromagnetic radiation with minimal losses due to absorption. Further, silicones are highly UV, visible and IR light stable, and are expected to have a similar lifespan to glass when used in solar concentrators, of the order of 25 to 30 years, or even longer. This is in contrast to thermoplastic microstructured films used in the prior art, which degrade on long exposure to UV, visible and/or IR light and must be replaced periodically to maintain desired performance levels. Silicones also can have low water absorption, and so can avoid damage to the optical element as a result of water ingress. As a result, it has been realized by the present inventors that a light-transmissive silicone layer may be used not only on the back surface of an optical element, but also or alternatively on the front surface of an optical element, as the light-transmissive silicone layer does not need to be protected from environmental conditions by a glass substrate.

When selecting a light-transmissive silicone for use in the present invention, those having high transparency to light, ie high light transmissivity, such as one which permits at least 90%, or at least 95%, of the intensity of incident UV and visible light to pass therethrough when applied as a light transmissive silicone coating according to the invention, good tolerance of outdoor conditions such as exposure to UV light, dust and other abrasives, and water, and an acceptable cost, are preferred. The curing time and conditions are also to be considered when selecting a silicone. Further, the light-transmissive silicone coating should be stable to the conditions expected in use for optical elements in a solar concentrator, typically −40° C. to +50° C. with humidity levels of from 0 to 100%. Specific silicones have been devised for outdoor use, such as PDMS. It is particularly preferred to use silicones selected from the group consisting of PDMS because of the high transmission of light in the full solar spectrum.

Preferably, the microstructured light-transmissive silicone coating is a continuous coating. This ensures the complete filling of all the microstructures of the mould, and also reduces the risk of water ingress between the silicone and the glass.

A further advantage of the use of silicones is that it is not necessary to use an adhesive layer or coating of adhesion promoter to adhere, or to assist in adhesion of, the microstructured coating to the substrate, again in contrast to prior art arrangements, as silicones adhere well to glass. The use of an adhesive increases the cost and complexity of manufacture. Further, adhesives and adhesion promoters may be susceptible to UV or light induced degradation, and may allow water to be absorbed into the optical element. Accordingly, avoidance of the use of adhesives or coatings of adhesion promoters eliminates these problems.

However, where the optical elements are large-scale elements, such as are required in commercial solar concentrators, the adhesion between the silicone and the glass needs to be reliably high across the entire substrate surface. Where a silicone coating is provided on the front surface of an optical element, and thus exposed to weathering in use and to washing to remove dust from the front surface of the element, the adhesion between the silicone and the glass substrate is particularly important. In addition, where a protective film is provided on the microstructured surface of the silicone layer to protect the microstructures during transit and storage prior to installation in a solar concentrator, or other use, it is necessary for the protective film to be easily removable from the silicone layer without disrupting the integrity of the silicone layer. Similar considerations may apply where optical elements are stacked without protective films being present on the surface(s) of the element that are coated with silicone, as contact between the silicone layer of one element and that of an adjacent element, or between the silicone layer of one element and the substrate of an adjacent element, in the stack may lead to adhesion between the adjacent elements, and thus to damage to the silicone layer when the elements in the stack are separated from one another.

Preferably, a protective film is provided on the structured side of the silicone coating, ie that side of the silicone coating that is not in contact with the glass substrate. Suitably, the protective film is a thermoplastic film. Suitably, the protective film has formed thereon microstructures that are the inverse of the microstructures formed on the silicone coating, and which cooperate with the microstructures on the silicone coating. The protective film is removed from the optical element prior to its use.

Where a protective film is provided having formed thereon microstructures that are the inverse of the microstructures formed on the light-transmissive silicone coating, and which cooperate with the microstructures on the silicone coating, it is sometimes found that the adhesion between the silicone coating and the thermoplastic film is greater than that between the silicone coating and the glass substrate, due to the greater contact surface area between the thermoplastic film and the silicone coating compared to between the silicone coating and the glass substrate. This can lead to removal of the thermoplastic film also causing removal or partial removal of the light-transmissive silicone coating.

Accordingly, in the present invention, in order to address these problems or potential problems, the surface(s) of the glass substrate that are to be in contact with the light-transmissive silicone coating is/are roughened. Preferably, the roughening is produced by treating the surface(s) of the glass substrate itself to increase its roughness, for example by providing a surface texture thereon, rather than by application of a coating having higher roughness than that of the glass substrate surface. Suitably, the roughening or texturing can be produced by any suitable mechanical treatment applied to the surface of the glass substrate, such as blasting or grinding. However, these methods are difficult to control on glass, and so it is preferred that the roughening or texturing is conducted by etching the surface of the glass substrate. Preferably, the etching is carried out such that a porous structure or an open structure is etched into the surface of the substrate, by selection of the etching conditions as known to the skilled person. Preferably, the roughening is in the form of nanostructures on the surface of the glass substrate. In general, with increasing height of the nanostructures, the adhesion of the silicone coating is improved due to the higher contact area between the roughened glass substrate and the silicone coating. However, it is most preferable for the surface roughness or texture of the back surface of the glass substrate to be in the form of nanostructures having a maximum height of less than 1000 nm, preferably a maximum height of 500 nm, more preferably 400 nm and most preferably 300 nm, and a maximum width of 400 nm, more preferably a maximum width of 300 nm, as structures having a greater height and/or width will act to diffract light passing through the glass-silicone interface, and thus to spread the incident light rather than to focus it. Most preferably, the nanostructures have a height of 200 nm or more, in order to ensure a sufficient improvement in the adhesion between the silicone coating and the substrate compared with that between a silicone coating and an un-roughened glass substrate, which typically has a roughness of less than 5 nm, as well as functioning as an antireflective coating. Suitably, the measurement of the heights of the roughness can be an R_{z} measurement. Thus, the R_{z} value for the roughened surface is most preferably within the range of from 200 nm to 400 nm.

Preferably, the nanostructures have a width that is the same as their height. Preferably, the nanostructures have a real area/macroscopic area ratio of at least 1.1, preferably at least 1.2, such as at least 1.3, 1.4 or 1.5. Preferably, the nanostructures have an aspect ratio (that is, the ratio of the height of the nanostructures to the width of the nanostructures) of greater than or equal to 0.5. Preferably, the nanostructures have an aspect ratio of at most 1. Suitable surface roughening can be provided by antireflective gradient refractive index (GRIN) structures on the glass substrate. This has the additional benefit that reflection at the glass-silicone interface is slightly reduced. In addition, where it is desired to provide an antireflective treatment on the one face of the glass substrate that is not to be coated with a light-transmissive silicone coating, it is preferable from a point of view of simplifying construction of the optical element to provide the same type of antireflective treatment on both sides of the glass substrate; for example, where only the back surface of the substrate is to be provided with a microstructured light-transmissive silicone coating, the antireflective treatment on the front surface acts to reduce reflections, and that on the back surface acts primarily to improve adhesion of the silicone coating. Preferably, in this case, both the front and the back surfaces of the glass substrate are etched to provide GRIN nanostructures thereon.

In some embodiments, the optical element may further comprise a second light transmissive glass substrate, which may be placed in front of or behind (with reference to the intended direction of incident light) the first light transmissive glass substrate. These embodiments are particularly preferred where the optical elements are to be used in environments, such as desert environments, in which abrasion to the surfaces of the optical element by airborne particles such as sand or earth is expected to be a major cause of wear to the optical element. Preferably, where the first light transmissive glass substrate is provided with a light transmissive silicone coating on the back surface, the second light transmissive glass substrate is placed behind the first light transmissive glass substrate, thus protecting the silicone coating from abrasion by airborne particles. Preferably, where the first light transmissive glass substrate is provided with a light transmissive silicone coating on the front surface, the second light transmissive glass substrate is placed in front of the first light transmissive glass substrate, again thus protecting the silicone coating from abrasion by airborne particles. The second light transmissive glass substrate may be placed in contact with the first light transmissive glass substrate, or with the light transmissive silicone coating on the first light transmissive glass substrate. It is found that the pressure exerted by the second light transmissive glass substrate on the silicone coating is not sufficient to cause any problematic degree of deformation of the microstructures of the silicone coating. Alternatively, suitable spacers may be provided between the substrates to maintain the desired spacing between them. In either case, a suitable sealant may be used to isolate the spaces between the first and second light transmissive glass substrates from the ambient environment, in order to prevent the ingress of airborne abrasive particulates such as sand. Suitably, a dry gas, such as a dry inert gas, can be provided between the first and second light transmissive glass substrates, in order to prevent condensation forming between the substrates. Suitably, the second light transmissive glass substrate is formed of the same materials and having the same size as described above for the first light transmissive glass substrate; preferably the first and second light transmissive substrates are formed from the same materials and have the same dimensions. Suitably, the second light transmissive glass substrate may have an antireflective coating on its front and/or the back face, which antireflective coating is preferably as described above for the first light transmissive glass substrate. Suitably, the second light transmissive glass substrate may further comprise a light transmissive silicone coating having microstructures formed thereon on, on the front and/or the back face of the second light transmissive glass substrate; preferably, the light transmissive silicone coating is as described above for the first light transmissive glass substrate. In a preferred embodiment, where the first light transmissive glass substrate is provided with a light transmissive silicone coating on the back surface, the second light transmissive glass substrate is placed behind the first light transmissive glass substrate and is provided with a light transmissive silicone coating on the front surface. This arrangement provides a significant increase in the deflection angle that can be achieved using the optical element, and thus greatly shortens the focal distance of the optical element, compared with a similar optical element having the light-transmissive silicone coating on only one of the surfaces of the glass substrates. While this arrangement, having two substrates, is heavier and thus more costly to produce than the arrangement described previously in which a single substrate has microstructured silicone coatings on both faces, it has the advantage that the silicone coatings are protected from airborne abrasive particles by the glass substrates, and so this arrangement is preferred for use in locations where airborne abrasive particles are expected to be a significant cause of wear, such as desert environments.

In a third aspect, the present invention provides a solar concentrator comprising at least one optical element according to the second aspect of the invention.

Suitably, the solar concentrator may comprise more than one optical element according to the invention, in order that a solar concentrator of appropriate size for the intended location and purpose is provided. For example, in the context of a solar concentrator for domestic electricity production, which may for example be mounted on a roof, a suitable total area for solar collection may be 3 m×3 m. This may be provided by use of a single optical element of 3 m length×3 m width, or by a 6×6 array of optical elements each having 0.5 m length by 0.5 m width, or any other suitable arrangement, such as a 2×2 array of optical elements each having a length of 1.5 m and a width of 1.5 m. In the context of commercial solar electricity generation, a much larger active area may be required, which may be achieved by the use of large area optical elements, and/or incorporating a plurality of optical elements into a single solar concentrator, and/or the use of a plurality of solar concentrators. It will be appreciated by the skilled person that for any given purpose there will be a practical and cost limit on the maximum size of optical element that can be manufactured, transported and installed on a solar concentrator, and a practical limit on the number and combined weight of optical elements that can be installed on a solar concentrator that will limit the size of the active area of the solar concentrator, particularly if the solar concentrator incorporates means by which it can be aligned to receive the sun's radiation efficiently throughout the day.

Suitably, the solar concentrator further comprises one or more solar collectors, or receivers, positioned to receive the radiation passing through and focused by the optical elements. The one or more solar collectors are positioned within the focal area of the or each optical element comprised in the solar concentrator. Thus, one or more solar collector can be provided at each focal area of the solar concentrator: that might be a single focal area where the solar concentrator comprises a single optical element, or an array of optical elements that together act to focus radiation on to a single focal area, or may be a plurality of focal areas where the solar concentrator comprises a single optical element on which the Fresnel microstructures result in incident radiation being focused on to a plurality of focal areas or where the solar concentrator comprises a plurality of optical elements each acting to focus incident radiation on to corresponding focal areas. The solar collectors may each be selected from photovoltaic cells or a heat exchanger arranged to be heated by the incident solar radiation and to transfer that heat to a heat transfer fluid. Where the solar collector is a photovoltaic cell, suitable wiring and circuitry may be provided to transfer the electrical energy produced by the photovoltaic cell to a suitable consumer of, or storage medium for, electrical energy, such as a domestic electrical circuit or a battery. Where the solar collector is a heat exchanger, suitable conduits may be provided to convey the heat transfer fluid to a consumer of heat energy or a storage medium for heat energy, such as a steam generator, or a heat sink.

Preferably, the solar concentrator further comprises a support for the one or more optical elements, which support holds the one or more optical elements in a desired orientation, and, where more than one optical element is comprised in the solar concentrator, holds the plurality of optical elements in a desired relationship to one another. For example, the plurality of optical elements may be held in a planar array. Preferably, the support is arranged such that the area of the one or more optical elements through which radiation may be transmitted and focused is maximized; for example, at least 90% of the area of each of the one or more optical elements is available to transmit and focus incident radiation. Suitably, the support may comprise two or more supporting beams extending in a mutually parallel direction, for example with their longitudinal axes aligned and spaced at regular intervals, and preferably with their proximal ends being aligned with one another and their distal ends being aligned with one another, such that the two or more supporting beams define a quadrilateral plane, such as a rectangular or square plane.

Preferably, the solar concentrator further comprises a mount which allows the position of the one or more optical elements with respect to the incident radiation to be adjusted, preferably to allow the one or more optical elements to be placed such that the incident radiation is orthogonal to the plane of the substrate(s) of the one or more optical elements. Suitably the mount may comprise a swivel joint. Where a support is included in the solar concentrator, the mount is suitably fixed to the support and allows the position of the support to be adjusted. Preferably, the mount further comprises a solar tracker that acts to adjust the position of the one or more optical elements with respect to the incident radiation to maintain the incident radiation orthogonal (or as near as practically possible to orthogonal) to the plane of the substrate(s) of the one or more optical elements during a period of two or more hours, such as three or more hours, four or more hours, six or more hours, such as eight or more hours, such as 12 or more hours.

In a first aspect of the invention is provided a method of manufacture of an optical element for focusing electromagnetic radiation, comprising the steps of:
(a) providing a first light-transmissive glass substrate having a front surface on which the electromagnetic radiation is incident in use and a back surface opposite to the front surface;
(b) applying a liquid silicone resin to the back and/or the front surface of the glass substrate;
(c) contacting the liquid silicone resin with a mould such that the liquid silicone resin adopts the form of the mould and forms microstructures extending over the surface(s) of the glass substrate to which the liquid silicone resin has been applied;
(d) curing the liquid silicone resin to form a microstructured light-transmissive silicone coating;

wherein the surface(s) of the glass substrate to which the liquid silicone resin are to be applied is/are roughened.

Preferably, the mould has a form that causes, in step (c), the liquid silicone resin to adopt the form of microstructures that focus the electromagnetic radiation incident on the optical element in use.

Suitably, the optical element manufactured by the method is an optical element according to the second aspect of the invention. Accordingly, preferred features of the light transmissive glass substrate(s), the roughening or texturing of the surface(s) of the substrate(s), and the light-transmissive silicone coating(s) mentioned in the second aspect of the invention are preferred in the present aspect of the invention also.

Suitably, the method may further comprise the method of making a mould according to the fifth aspect of the invention, prior to step (c).

Suitably, the liquid silicone resin is one that is suitable for casting. Preferably, the liquid silicone resin is able to be cured by a combination of heat and time in a suitable combination, as discussed below regarding step (d). Details of preferred silicones for the light-transmissive silicone coating are given in the description of the third aspect of the invention, and are also preferred in the present aspect of the invention.

Preferably, step (a) further comprises the step of roughening or texturing the surface(s) of the glass substrate to which the liquid silicone resin is/are to be applied in step (b) in order to provide the roughened surface(s). Preferably, the roughening step comprises treating the surface of the glass substrate itself to increase its roughness, rather than application of a coating having higher roughness than that of the glass substrate surface. Suitably, the roughening can be carried out by any suitable mechanical treatment applied to the surface of the glass substrate, such as blasting or grinding. However, these methods are difficult to control on glass, and so it is preferred that the roughening is conducted by etching the surface of the glass substrate, preferably such that a porous structure or an open structure is etched into the surface of the substrate. Preferably, the roughening is in the form of nanostructures formed on the surface(s) of the glass substrate. Preferably, the surface roughness of the surface(s) of the glass substrate is in the form of nanostructures having a height of less than 1000 nm, preferably up to 800 nm, more preferably up to 600 nm, more preferably up to 500 nm, yet more preferably up to 400 nm, most preferably up to 300 nm. Preferably, the nanostructures have a height of 50 nm or more, preferably 100 nm or more, most preferably 200 nm or more. Suitably, 20 the measurement of the heights of the roughness can be an R_{z} measurement. Thus, the R_{z} value for the roughened surface is preferably within the range of from 50 nm to 800 nm, more preferably from 100 nm to 600 nm, most preferably from 200 nm to 400 nm. Preferably, the nanostructuring step comprises providing a GRIN antireflective treatment on the surface(s) of the glass substrate.

Alternatively, in step (a), a light transmissive glass substrate already comprising a roughened front and/or back surface, preferably a front and/or back surface having nanostructures thereon as described above, may be provided.

Preferably, where only one of the surface of the glass substrate is to be coated with liquid silicone resin in step (b), the other surface of the glass substrate is provided with an antireflective treatment or coating. Suitably, following step (a) and before step (b) the method further comprises the step of applying an antireflective treatment or coating to the surface of the glass substrate to which the liquid silicone resin is not to be applied in step (b). Suitable antireflective treatments or coatings are described with reference to the first aspect of the invention. Alternatively, in step (a) a light transmissive glass substrate already comprising an antireflective treatment or coating on the surface to which the liquid silicone resin is not to be applied in step (b), preferably an antireflective treatment as described above, may be provided.

In step (b), the application of the liquid silicone resin may carried out by any suitable method known in the art for providing a layer of a liquid on a surface. For example, spin coating (if the substrate size allows) or knife coating can be used. Preferably, however, one or more droplets, pools or areas of liquid silicone resin can be applied to the surface, for example from a nozzle, without any active spreading of the one or more droplets, pools or areas into a continuous layer during the application step. Of course, depending on the viscosity of the liquid silicone resin, and its ability to wet the surface of the glass substrate, the liquid silicone resin may spread to some extent of its own accord.

In step (c), the mould may take any suitable form or be made of any suitable material to form the liquid silicone resin into a coating extending over the back surface of the glass substrate which coating adopts the form of the mould. The mould must also withstand the conditions used in the curing step (d), as it is necessary for the mould to remain in place until the liquid silicone resin is cured. For example, the mould may be a stamp or a structured roller. The mould may be of plastics material, metal, glass or ceramic, and may be flexible or rigid. The mould preferably has a width and length equal to or exceeding the width and length of the light transmissive glass substrate, in order that the whole of the surface of the substrate can be coated with the microstructured light-transmissive silicone coating using a single mould.

Where a structured roller is used as the mould, it is necessary to select the liquid silicone resin, the temperature of the roller, and the speed of rotation of the roller such that the liquid silicone resin is able to fill the structures of the roller and to coat the glass substrate and then to be cured such that it retains its structured form all within the time for which the structured roller remains in contact with the silicone layer on the glass substrate.

Preferably, the mould is a thermoplastic film, one surface of which has formed thereon microstructures that are the inverse of the microstructures that, when adopted by the light-transmissive silicone coating, act to focus the electromagnetic radiation incident on the optical element in use. Preferably, the thermoplastic film is flexible, for example such that it may be peeled from the surface of the silicone coating after curing. In this connection, preferably, the thermoplastic film is a polypropylene film or a polyethylene film, and, preferably, the thermoplastic film has a thickness of from 40 μm to 200 μm. Where a thermoplastic film is used, it is preferably used only for a single moulding step (c).

Where the mould is a thermoplastic film, preferably, in step (c), the contacting of the liquid silicone resin with the mould comprises pressing the thermoplastic film surface on which the microstructures are formed against the liquid silicone resin in order that the liquid silicone resin adopts the form of the microstructures. Preferably, step (c) further comprises aligning the thermoplastic film with the light transmissive glass substrate in order that the thermoplastic film is superimposed on the glass substrate and the whole of the substrate is coated with the microstructured light-transmissive silicone coating. However, it can be envisaged in certain circumstances that it may be desired to provide microstructures over less than the whole area of the substrate, for example to leave a border around the edges of the substrate free from microstructures. In these cases, either a mould that has an area smaller than that of the substrate may be used, or a mould that is only partially covered in microstructures may be used. Preferably, the pressing of the thermoplastic film against the liquid silicone resin also spreads the liquid silicone resin to form a continuous coating extending over the back surface of the glass substrate. Preferably, pressing the thermoplastic film against the liquid silicone resin is carried out using a roller. Where a roller is used, it preferably has a width equal to or exceeding that of the light transmissive glass substrate, in order that even pressure can be applied across the whole width of the substrate. Preferably, the roller is applied with even pressure along the whole of the length of the substrate in order that the liquid silicone resin is patterned and spread uniformly on the whole area of the substrate.

In step (d), the curing may be carried out by any suitable curing method applicable to the chosen liquid silicone resin and which the substrate and the mould is able to withstand; for example, the curing may comprise UV exposure, heat, time, or a combination thereof. Preferably, however, the curing is carried out using a combination of heat and time. For example, for a selected liquid silicone resin, the curing conditions may be 24 hours at ambient temperature, such as at 20° C., 10 hours at 40° C., or 1 hour at 70° C. It will be understood by the skilled person that a balance between the temperature of curing and the time of curing can be found for a given resin depending on the process requirements; for example, the availability of suitable heating apparatus or the time available for curing. Preferably, the curing does not comprise the use of UV radiation to initiate the curing process.

Following the curing step (d), and where the mould is in the form of a stamp, a thermoplastic film, or other suitable form, the mould may be left in place on the cured light-transmissive silicone coating to act as a protective layer for the coating prior to its use as an optical element. This is particularly preferable where the mould is a thermoplastic film as described above.

Where it is desired to provide a microstructured light-transmissive silicone coating on both the front surface and the back surface of the glass substrate, it is possible for steps (b), (c) and (d) of the method to be carried out twice, once for the front and once for the back surface; or for steps (b) and (c) to be carried out twice, once for the front and once for the back surface, followed by step (d) to cure both silicone coatings; or for step (b) to be carried out to both the front and back surfaces of the glass substrate, followed by step (c) on both the front and back surfaces, followed by step (d) on both the front and back surfaces.

Preferably, the method comprises the further step of:
(e) removing the mould from the microstructured light-transmissive silicone coating.

Preferably, the removal step (e), where the mould is a thermoplastic film as described above, comprises peeling of the thermoplastic film from the light-transmissive silicone coating.

As described above for the second aspect of the invention, and particularly where the mould is a thermoplastic microstructured film and is used as a protective layer to be removed from the light-transmissive silicone coating prior to use, the surface(s) of the glass substrate to which the liquid silicone resin is to be applied is/are roughened to ensure that the adhesion between the silicone coating and the glass substrate is greater than the adhesion between the silicone coating and the thermoplastic film, thus ensuring that the removal of the thermoplastic film does not result in removal or partial removal of the silicone coating from the glass substrate.

As described above for the second aspect of the invention, the optical element may further comprise a second light transmissive glass substrate, which may have light transmissive silicone coatings provided on one or both faces thereof. Where the second substrate is provided, the surface roughening and/or the light transmissive silicone coating(s), where provided, are formed according to the method of the first aspect of the invention. The two light transmissive glass substrates, with coatings thereon as desired, are then superimposed on one another and fixed together, either in contact with one another, or in a spaced relationship to one another by means of spacers placed between the substrates and adhered or fixed to the substrates. Where the light transmissive silicone coating(s) of the optical element would thereby be placed between the two substrates, it will be understood that the step (e) of removing the mould from the microstructured light transmissive silicone coating(s) must be carried out before the superimposition of the substrates and fixing of them to one another. Suitable sealants, as known to the skilled person, may be used to prevent ingress of the ambient atmosphere between the two substrates, and the area between the two substrates may be filled with a dry gas, such as a dry inert gas.

In a fourth aspect of the present invention is provided a method of manufacture of a solar concentrator, comprising the steps of:
i) providing one or more optical elements for focusing solar radiation, the one or more optical elements comprising:
   a light-transmissive glass substrate having a front surface on which the electromagnetic radiation is incident in use and a back surface opposite to the front surface; and
   a light-transmissive silicone coating on the back and/or the front surface of the substrate;
   wherein the light-transmissive silicone coating has formed thereon microstructures that focus the solar radiation incident on the optical element in use, and
   wherein the surface(s) of the glass substrate on which the light-transmissive silicone coating is formed is/are roughened;
ii) arranging the one or more optical elements to focus solar radiation to one or more focal areas;
iii) placing a collector of solar energy at the or each focal area.

Preferably, the one or more optical elements are each according to the second aspect of the invention. Preferably, the solar concentrator is according to the third aspect of the invention. Preferably, the method further comprises manufacture of the one or more optical elements according to the first aspect of the invention. Where the optical element is manufactured according to the first aspect of the invention, the method preferably comprises step (e) of the method of the first aspect of the invention. Where the optical element according to the second aspect of the invention is used and comprises a protective film on the structured side of the light-transmissive silicone coating, the method preferably further comprises the step of removing the protective film prior to step ii).

In a fifth aspect, the present invention provides a method of manufacture of a mould for shaping a liquid silicone resin on a glass substrate for an optical element, wherein the mould is a thermoplastic film, one surface of which has formed thereon inverse microstructures that are the inverse of the microstructures that, when adopted by the liquid silicone resin, focus electromagnetic radiation incident on the optical element in use, the method comprising the steps of:
providing a rotating extrusion coating roller for a polymer extrusion coating process using a thermoplastic material, which extrusion coating roller has the inverse microstructures formed on its surface;
maintaining the temperature of the rotating extrusion coating roller below the solidification temperature of the thermoplastic material;
moving a carrier foil between the rotating extrusion coating roller and a rotating counter pressure roller at a given velocity corresponding to the rotational velocity of the rotating extrusion coating roller
continuously applying a melt of the thermoplastic material between the moving carrier foil and the rotating extrusion coating roller, whereby said thermoplastic melt is solidified upon contact with said extrusion coating roller, thereby forming a solid microstructured thermoplastic coating on said carrier foil.

Suitably, the extrusion coating roller is a steel cooling roller coated with a metal master, such as a nickel sleeve, having microstructures formed thereon. Alternatively, the microstructures can be formed by imprinting them on the surface of a conventional extrusion coating roller. Preferably, the microstructures are Fresnel microstructures, such as part circular Fresnel lens microstructures. The microstructures may be formed in the metal master using any suitable method, such as single point diamond turning. Suitably, the extrusion coating roller and/or the counterpressure roller may be cooled by any suitable cooling method, such as by circulation of water or other coolant fluid through the interior of the roller.

Suitably, the carrier foil is a thermoplastic foil having a softening temperature that is sufficiently high that the extrusion of molten polymer thereon will not cause softening or deformation of the carrier foil. Suitable carrier foil materials are PET (polyethylene terephthalate) or nylon. Preferably, the carrier foil is PET (polyethylene terephthalate). Suitably, the thickness of the carrier foil is from 12 μm to 75 μm, such as 50 μm.

Suitably, the thermoplastic material is a thermoplastic polymer having a softening temperature that is sufficiently lower than that of the carrier foil that the molten thermoplastic polymer can be applied to the carrier foil without causing softening or deformation of the carrier foil. Suitable thermoplastic materials include polyethylene, polypropylene, or ionomer resins such as Surlyn®. Preferably, the thermoplastic material is polypropylene. Suitably, the thickness of the melt of the thermoplastic material that is applied to the moving carrier foil is from 10 to 80 μm, preferably 30 μm to 60 μm, such as 45 μm.

Suitably, the mould, and thus the carrier foil, has the same width as the glass substrate to which it is intended to apply the mould; accordingly, the width dimensions discussed above with respect to the glass substrate are also preferable for the mould and the carrier foil.

As it is preferred in some aspects of the invention to use the mould not only as a mould but also as a protective film to protect the microstructured silicone coating during storage and transit prior to installation of the optical element in a solar concentrator, it is preferred that the materials used for the carrier foil in particular, and to some extent also the thermoplastic material, are chosen with this purpose in mind. Thus, the carrier foil, which is exposed to the surroundings when the mould is left in place as a protective film, should be resistant to scratching and abrasion to ensure that the silicone coating is untouched by such contacts with the mould. Preferably, therefore, the carrier foil is PET.

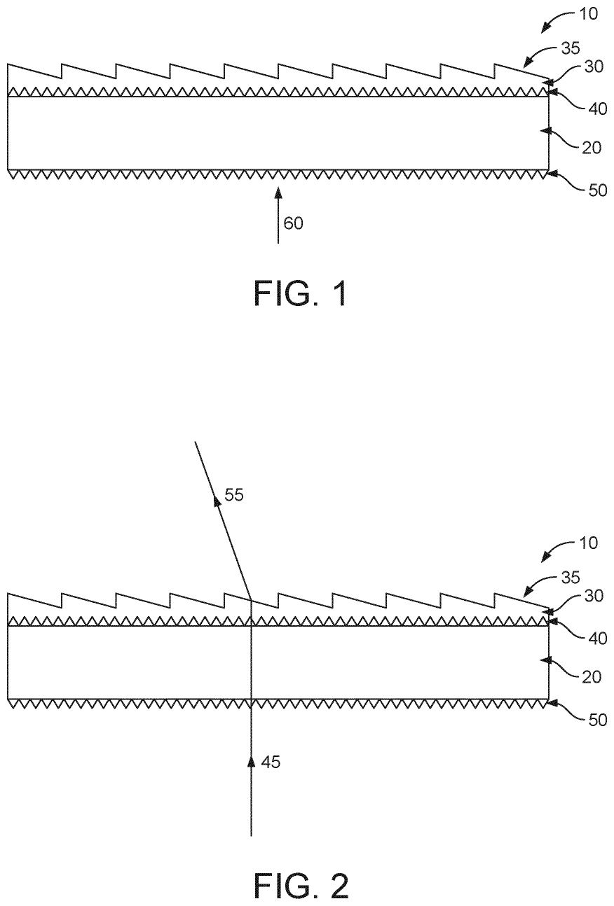

FIG. 1 depicts an embodiment of the optical element 10 of the present invention. Optical element 10 comprises light transmissive glass substrate 20, which is formed from iron-free glass and has a thickness of 5 mm and a length and width of 1500 mm. The light transmissive glass substrate 20 is provided with antireflective nanostructured coatings 40 and 50. The antireflective nanostructured coating 40 is provided on the back surface of the light transmissive glass substrate 20, and the antireflective nanostructured coating 50 on the front surface of light transmissive glass substrate 20, with respect to the direction of incident electromagnetic radiation in use, shown by arrow 60. The antireflective nanostructured coatings 40 and 50 are graded refractive index coatings having an R_{z} value of 300 nm, an aspect ratio of 0.75 and a real area/macroscopic area ratio of 1.5, and may be provided by etching the surface of the light transmissive glass substrate 20. On the back surface of light transmissive glass substrate 20, in contact with antireflective nanostructured coating 40, is provided light-transmissive silicone coating 30 of PDMS having a microstructured surface, in which the microstructures are Fresnel microstructures 35.

In use, sunlight is incident on the optical element 10 in the direction of arrow 60. FIG. 2 shows the optical element 10 in use, with incident sunlight 45 normal to the front surface of light transmissive glass substrate 20, and passing through the antireflective nanostructured coating 50, light transmissive glass substrate 20, antireflective nanostructured coating 40 and into the microstructured light-transmissive silicone coating 30 without refraction. When the incident sunlight 45 reaches the Fresnel microstructures 35 at the back face of silicone coating 30, the sunlight is refracted by the microstructure to an angle (relative to normal) of twice the Fresnel tilt angle, and is also refracted as a result of the change of refractive index between the silicone and the air at the back face of the optical element. Thus, the focused light 55 exits the back face of the optical element 10 at a different angle from the angle at which the incident light 45 entered the silicone coating layer 30. The refraction of the light as it passes through the optical element serves to focus the light on to a focal area at which a solar collector (not shown) is present to receive the focused light.

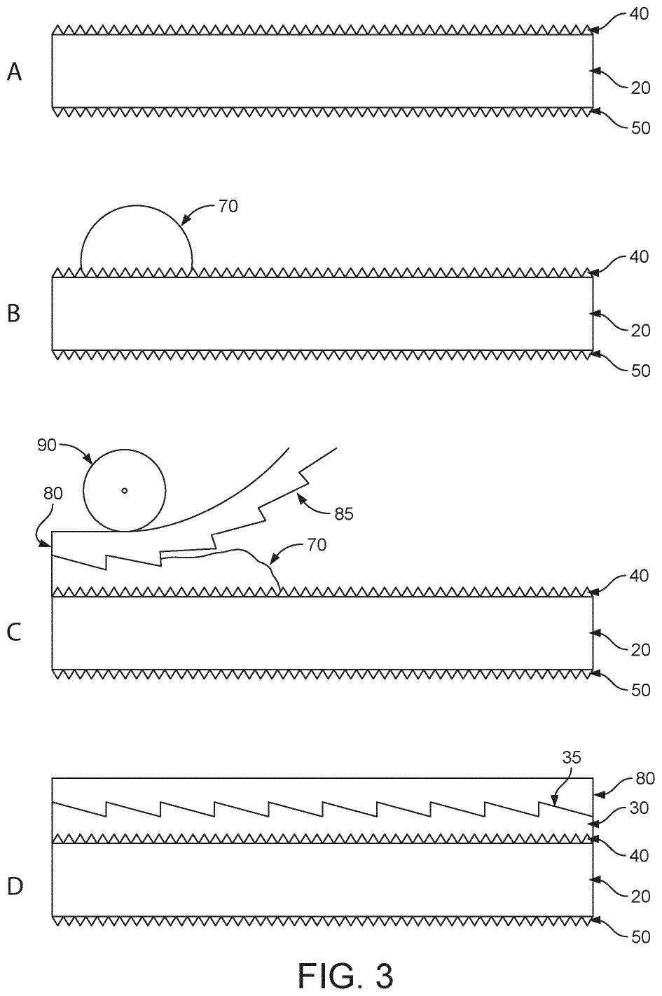

Turning to FIG. 3, this Figure shows the manufacture of an embodiment of the optical element of the invention according to an embodiment of the method of manufacture of the invention.

FIG. 3A is relevant to step (a) of the method of the invention, and shows light transmissive glass substrate 20 having antireflective nanostructured coatings 40 and 50 on the back and front surfaces, respectively, thereof.

FIG. 3B is relevant to step (b) of the method of the invention. A drop or pool of liquid silicone resin 70 is applied to the back surface of the light transmissive glass substrate 20, in contact with the antireflective nanostructured coating 40 on the back surface of the substrate 20. No active steps are taken to spread the drop or pool of the liquid silicone resin 70 on to the substrate 20 to form a continuous coating at this stage.

FIG. 3C is relevant to step (c) of the method of the invention. A mould in the form of thermoplastic film 80, having the same dimensions as the light transmissive glass substrate 20 and having on one surface Fresnel microstructures 85 that are the inverse of the Fresnel microstructures to be formed on the optical element, is placed in contact with the drop or pool of liquid silicone resin 70 and the edges of the thermoplastic film 80 aligned with the edges of the light transmissive glass substrate 20. A roller 90 having a width equal to or exceeding the width of the light transmissive glass substrate 20 and the thermoplastic film 80 is placed in contact with the unstructured surface of the thermoplastic film 80, that is, the side of the thermoplastic film 80 that is not in contact with the drop or pool of liquid silicone resin 70, and presses the thermoplastic film 80 against the light transmissive glass substrate 20, thus spreading the drop or pool of liquid silicone resin 70 across the back surface of the light transmissive glass substrate 20 such as to coat the back surface, and also causing the liquid silicone resin 70 to adopt the form of the microstructures formed on the thermoplastic film 80. The roller 90 is rolled along the length of the light transmissive glass substrate 20 (from left to right as depicted in FIG. 3C) in order successively to press areas of the thermoplastic film 80 into contact with the liquid silicone resin 70 and against the light transmissive glass substrate 20, until the whole of the thermoplastic film 80 extends over the light transmissive glass substrate 20 and the liquid silicone resin 70 is spread between the thermoplastic film 80 and light transmissive glass substrate 20 and has filled the microstructures 85 of the thermoplastic film 80 so as to adopt their shape.

FIG. 3D is relevant to step (d) of the method of the invention. The assembly of the light transmissive glass substrate 20, liquid silicone resin 70 and thermoplastic film 80 is subjected to the curing conditions suitable to the liquid silicone resin 70, such as heating at 40° C. for 10 h. During this time, the liquid silicone resin 70 cures and solidifies, permanently adopting the form of the Fresnel microstructures 85 of the thermoplastic film 80, thus forming light-transmissive silicone coating 30 having thereon Fresnel microstructures 35.

The thermoplastic film 80 may be left in contact with the light-transmissive silicone coating 30 following the curing step to function as a protective film until such time as the optical element 10 is incorporated into a solar concentrator or otherwise put into use. At that time, the thermoplastic film 80 can be peeled away from the light-transmissive silicone coating 30 and discarded or reused.

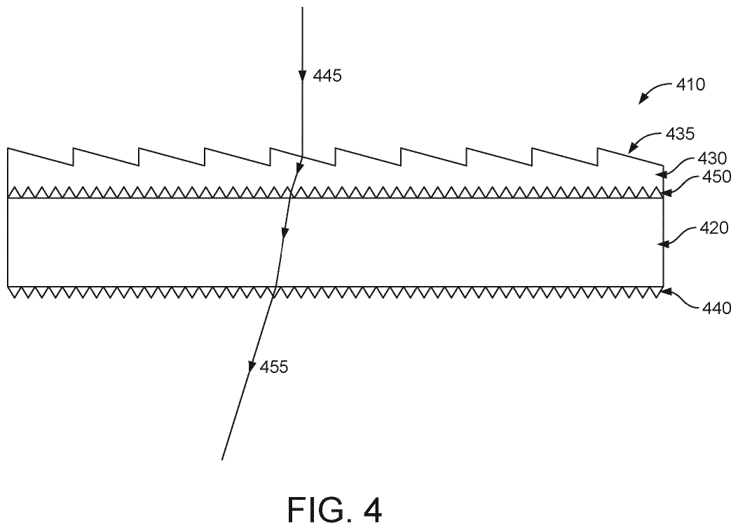

FIG. 4 depicts an alternative embodiment of the optical element 410 of the present invention. Optical element 410 comprises light transmissive glass substrate 420. The light transmissive glass substrate 420 is provided with antireflective nanostructured coatings 440 and 450. The antireflective nanostructured coating 440 is provided on the back surface of the light transmissive glass substrate 420, and the antireflective nanostructured coating 450 on the front surface of light transmissive glass substrate 420, with respect to the direction of incident electromagnetic radiation in use, shown by arrow 445. On the front surface of light transmissive glass substrate 420, in contact with antireflective nanostructured coating 450, is provided light-transmissive silicone coating 430 having a microstructured surface, in which the microstructures are Fresnel microstructures 435.

In use, sunlight is incident on the optical element 410 in the direction of arrow 445. FIG. 4 shows the optical element 410 in use, with incident sunlight 445 normal to the front surface of light transmissive glass substrate 420, and passing through the microstructured light-transmissive silicone coating 430, the antireflective nanostructured coating 450, light transmissive glass substrate 420, and antireflective nanostructured coating 440. When the incident sunlight 445 is incident upon the Fresnel microstructures 435 at the front face of silicone coating 430, the sunlight is refracted by the microstructure to an angle (relative to normal) of twice the Fresnel tilt angle, and is also refracted as a result of the change of refractive index between the air and the silicone layer at the front face of the optical element. The sunlight is subsequently refracted as a result of the refractive index changes at the junction of the silicone coating 430 and light transmissive substrate 420, and at the junction of light transmissive substrate 420 and the surroundings. The focused light 455 thus exits the back face of the optical element 410 at a different angle from the angle at which the incident light 445 entered the silicone coating layer 430. The refraction of the light as it passes through the optical element serves to focus the light on to a focal area at which a solar collector (not shown) is present to receive the focused light.

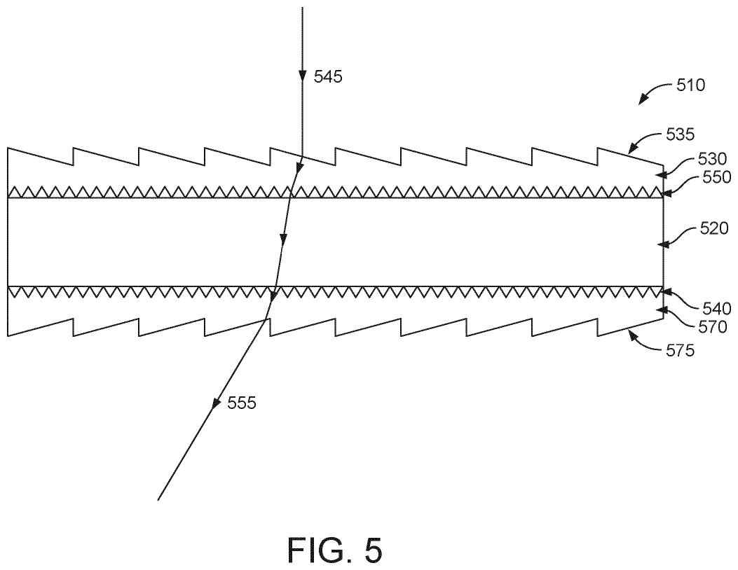

FIG. 5 depicts a further alternative embodiment of the optical element 510 of the present invention. Optical element 510 comprises light transmissive glass substrate 520. The light transmissive glass substrate 520 is provided with antireflective nanostructured coatings 540 and 550. The antireflective nanostructured coating 540 is provided on the back surface of the light transmissive glass substrate 520, and the antireflective nanostructured coating 550 on the front surface of light transmissive glass substrate 520, with respect to the direction of incident electromagnetic radiation in use, shown by arrow 545. On the front surface of light transmissive glass substrate 520, in contact with antireflective nanostructured coating 550, is provided light-transmissive silicone coating 530 having a microstructured surface, in which the microstructures are Fresnel microstructures 535. Similarly, on the back surface of light transmissive glass substrate 520, in contact with antireflective nanostructured coating 540, is provided light-transmissive silicone coating 570 having a microstructured surface, in which the microstructures are Fresnel microstructures 575.

In use, sunlight is incident on the optical element 510 in the direction of arrow 545. FIG. 5 shows the optical element 510 in use, with incident sunlight 545 normal to the front surface of light transmissive glass substrate 520, and passing through the microstructured silicone coating 530, the antireflective nanostructured coating 550, light transmissive glass substrate 520, antireflective nanostructured coating 540, and microstructured silicone coating 570. When the incident sunlight 545 is incident upon the Fresnel microstructures 535 at the front face of silicone coating 530, the sunlight is refracted by the microstructure to an angle (relative to normal) of twice the Fresnel tilt angle, and is also refracted as a result of the change of refractive index between the air and the silicone at the front face of the optical element. The sunlight is subsequently refracted as a result of the changes in refractive index at the junction of the silicone coating 530 and light transmissive substrate 520, at the junction of light transmissive substrate 420 and microstructured silicone coating 570. On exiting the back surface of microstructured silicone coating 570 via the microstructures 575, the sunlight is again refracted to an angle (relative to normal) of twice the Fresnel tilt angle, and is also refracted as a result of the change of refractive index between the silicone and the air at the back face of the optical element. Thus, the focused light 555 exits the back face of the optical element 510 at a different angle from the angle at which the incident light 545 entered the silicone coating layer 530. The refraction of the light as it passes through the optical element serves to focus the light on to a focal area at which a solar collector (not shown) is present to receive the focused light. This embodiment of the invention provides a high degree of refraction of incident light while minimizing the weight and cost of the optical element.

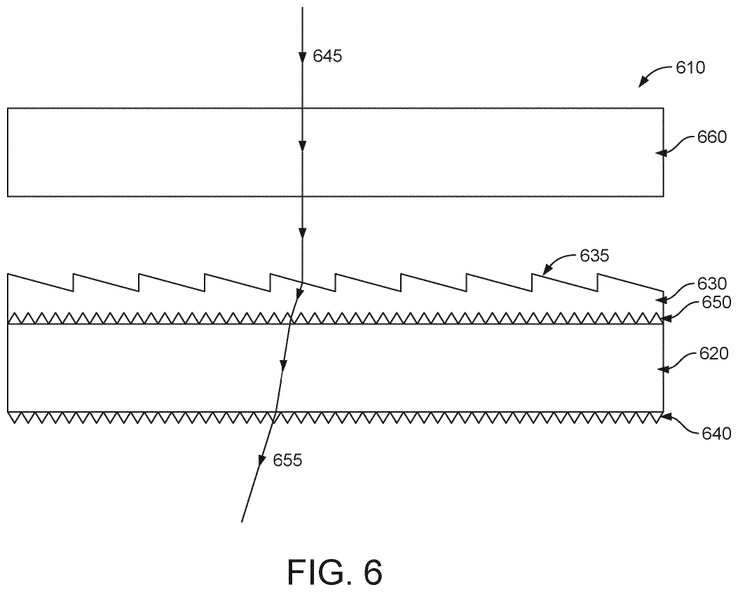

FIG. 6 depicts an alternative embodiment of the optical element 610 of the present invention. Optical element 610 comprises first light transmissive glass substrate 620. The first light transmissive glass substrate 620 is provided with antireflective nanostructured coatings 640 and 650. The antireflective nanostructured coating 640 is provided on the back surface of the first light transmissive glass substrate 620, and the antireflective nanostructured coating 650 on the front surface of first light transmissive glass substrate 620, with respect to the direction of incident electromagnetic radiation in use, shown by arrow 645. On the front surface of first light transmissive glass substrate 620, in contact with antireflective nanostructured coating 650, is provided light-transmissive silicone coating 630 having a microstructured surface, in which the microstructures are Fresnel microstructures 635. In addition, the optical element comprises second light transmissive glass substrate 660 which intervenes between the light-transmissive silicone coating 630 and incident light 645, that is, is placed at the front side of first light transmissive glass substrate 620, in contact with the light transmissive silicone coating 630, though for clarity the elements 660 and 630 are shown spaced apart in the Figure. Second light transmissive glass substrate 660 may be provided with antireflective coating(s) (not shown) on the front face and/or the back face.

In use, sunlight is incident on the optical element 610 in the direction of arrow 645. FIG. 6 shows the optical element 610 in use, with incident sunlight 645 normal to the front surface of second light transmissive glass substrate 660, and passing through the second light transmissive glass substrate 660 without refraction, followed by the microstructured light-transmissive silicone coating 630, the antireflective nanostructured coating 650, first light transmissive glass substrate 620, and antireflective nanostructured coating 640. When the incident sunlight 645 is incident upon the Fresnel microstructures 635 at the front face of silicone coating 630, the sunlight is refracted by the microstructure to an angle (relative to normal) of twice the Fresnel tilt angle, and is also refracted as a result of the change of refractive index between the air and the silicone layer at the front face of the optical element. The sunlight is subsequently refracted as a result of the refractive index changes at the junction of the silicone coating 630 and first light transmissive substrate 620, and at the junction of first light transmissive substrate 620 and the surroundings. The focused light 655 thus exits the back face of the optical element 610 at a different angle from the angle at which the incident light 645 entered the silicone coating layer 630. The refraction of the light as it passes through the optical element serves to focus the light on to a focal area at which a solar collector (not shown) is present to receive the focused light. The presence of the second light transmissive glass substrate 660 serves to protect the microstructured light-transmissive silicone coating 630 from abrasion from airborne particulates incident on the front face of the optical element.

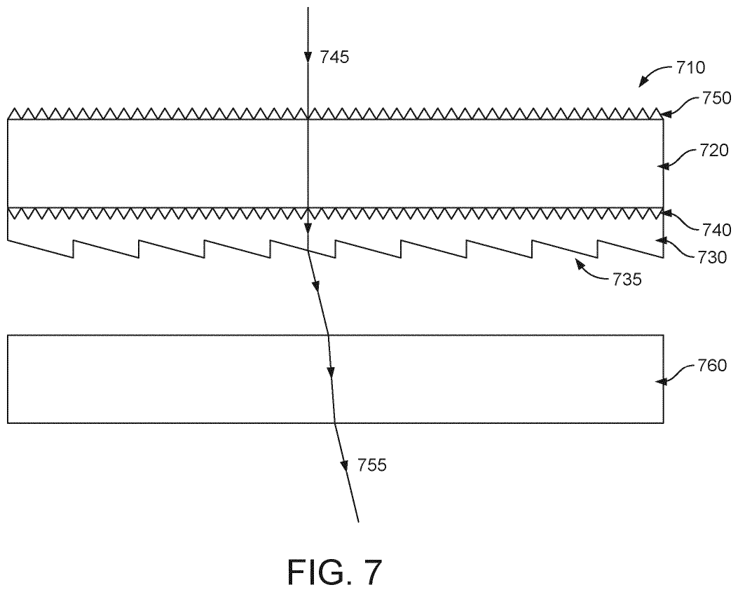

FIG. 7 depicts a further alternative embodiment of the optical element 710 of the present invention. Optical element 710 comprises first light transmissive glass substrate 720. The first light transmissive glass substrate 720 is provided with antireflective nanostructured coatings 740 and 750. The antireflective nanostructured coating 740 is provided on the back surface of the first light transmissive glass substrate 720, and the antireflective nanostructured coating 750 on the front surface of first light transmissive glass substrate 720, with respect to the direction of incident electromagnetic radiation in use, shown by arrow 745. On the back surface of first light transmissive glass substrate 720, in contact with antireflective nanostructured coating 740, is provided light-transmissive silicone coating 730 having a microstructured surface, in which the microstructures are Fresnel microstructures 735. In addition, the optical element comprises second light transmissive glass substrate 760 which is placed at the back side of first light transmissive glass substrate 720 in contact with the light transmissive silicone coating 730, though for clarity the elements 760 and 730 are shown spaced apart in the Figure. Second light transmissive glass substrate 760 may be provided with antireflective coating(s) (not shown) on the front face and/or the back face.

In use, sunlight is incident on the optical element 710 in the direction of arrow 745. FIG. 7 shows the optical element 710 in use, with incident sunlight 745 normal to the front surface of first light transmissive glass substrate 720, and passing through the antireflective nanostructured coating 750, first light transmissive glass substrate 720, antireflective nanostructured coating 740 and into the microstructured light-transmissive silicone coating 730 without refraction. When the incident sunlight 745 reaches the Fresnel microstructures 735 at the back face of silicone coating 730, the sunlight is refracted by the microstructure to an angle (relative to normal) of twice the Fresnel tilt angle, and is also refracted as a result of the change of refractive index between the silicone and the air at the back face of the optical element. The refracted light then passes through the second light transmissive glass substrate 760, undergoing refraction as a result of the change of refractive index between the air and the glass at the front face of the second light transmissive glass substrate 760, and as a result of the change of refractive index between the glass and the air at the back face of the optical element 710. Thus, the focused light 755 exits the back face of the optical element 710 at a different angle from the angle at which the incident light 745 entered the silicone coating layer 730. The refraction of the light as it passes through the optical element serves to focus the light on to a focal area at which a solar collector (not shown) is present to receive the focused light. The presence of the second light transmissive glass substrate 760 serves to protect the microstructured light-transmissive silicone coating 730 from abrasion from airborne particulates incident on the back face of the optical element.

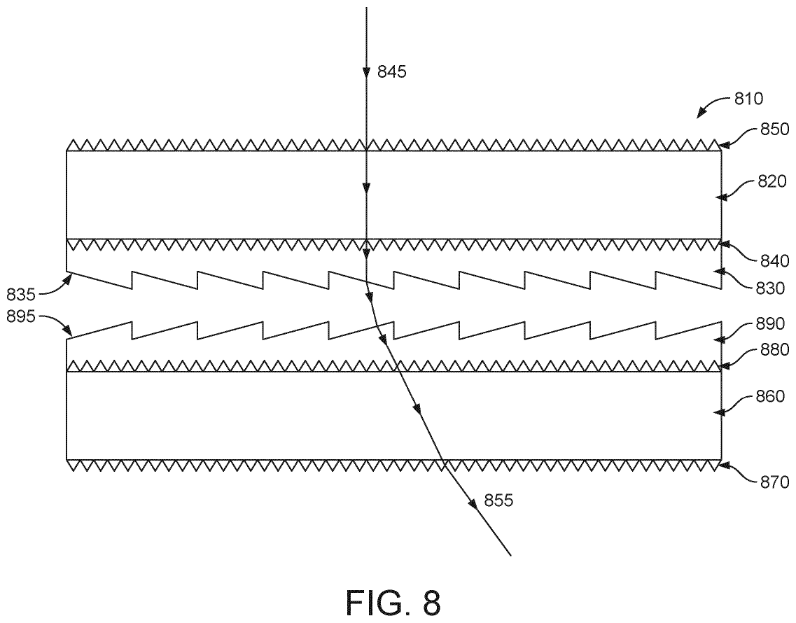

FIG. 8 depicts a further alternative embodiment of the optical element 810 of the present invention. Optical element 810 comprises first light transmissive glass substrate 820. The first light transmissive glass substrate 820 is provided with antireflective nanostructured coatings 840 and 850. The antireflective nanostructured coating 840 is provided on the back surface of the first light transmissive glass substrate 820, and the antireflective nanostructured coating 850 on the front surface of first light transmissive glass substrate 820, with respect to the direction of incident electromagnetic radiation in use, shown by arrow 845. On the back surface of first light transmissive glass substrate 820, in contact with antireflective nanostructured coating 840, is provided light-transmissive silicone coating 830 having a microstructured surface, in which the microstructures are Fresnel microstructures 835. In addition, the optical element comprises second light transmissive glass substrate 860 which is placed at the back side of first light transmissive glass substrate 820. The second light transmissive glass substrate 860 is provided with antireflective nanostructured coatings 870 and 880. The antireflective nanostructured coating 870 is provided on the back surface of the second light transmissive glass substrate 860, and the antireflective nanostructured coating 880 on the front surface of second light transmissive glass substrate 860, with respect to the direction of incident electromagnetic radiation in use, shown by arrow 845. On the front surface of second light transmissive glass substrate 860, in contact with antireflective nanostructured coating 880, is provided light-transmissive silicone coating 890 having a microstructured surface, in which the microstructures are Fresnel microstructures 895. The light transmissive silicone coating 890 is placed in contact with the light transmissive silicone coating 830, though for clarity the elements 890 and 830 are shown spaced apart in the Figure.

In use, sunlight is incident on the optical element 810 in the direction of arrow 845. FIG. 8 shows the optical element 810 in use, with incident sunlight 845 normal to the front surface of first light transmissive glass substrate 820, and passing through the antireflective nanostructured coating 850, first light transmissive glass substrate 820, antireflective nanostructured coating 840 and into the microstructured light-transmissive silicone coating 830 without refraction. When the incident sunlight 845 reaches the Fresnel microstructures 835 at the back face of silicone coating 830, the sunlight is refracted by the microstructure to an angle (relative to normal) of twice the Fresnel tilt angle, and is also refracted as a result of the change of refractive index between the silicone and the air at the back face of the optical element. The refracted light then is incident upon the Fresnel microstructures 895 at the front face of silicone coating 890, and the sunlight is refracted by the microstructures to an angle (relative to normal) of twice the Fresnel tilt angle, and is also refracted as a result of the change of refractive index between the air and the silicone layer 890. The light is subsequently refracted as a result of the refractive index changes at the junction of the silicone coating 890 and second light transmissive substrate 860, and at the junction of second light transmissive substrate 860 and the surroundings. Thus, the focused light 855 exits the back face of the optical element 810 at a different angle from the angle at which the incident light 845 entered the silicone coating layer 830. The refraction of the light as it passes through the optical element serves to focus the light on to a focal area at which a solar collector (not shown) is present to receive the focused light. The arrangement of the two substrates each with facing microstructured silicone coatings thereon serves to provide a high degree of refraction of incident light while also protecting the microstructured silicone coatings from abrasion by airborne particles incident on the front and back faces of the optical element.

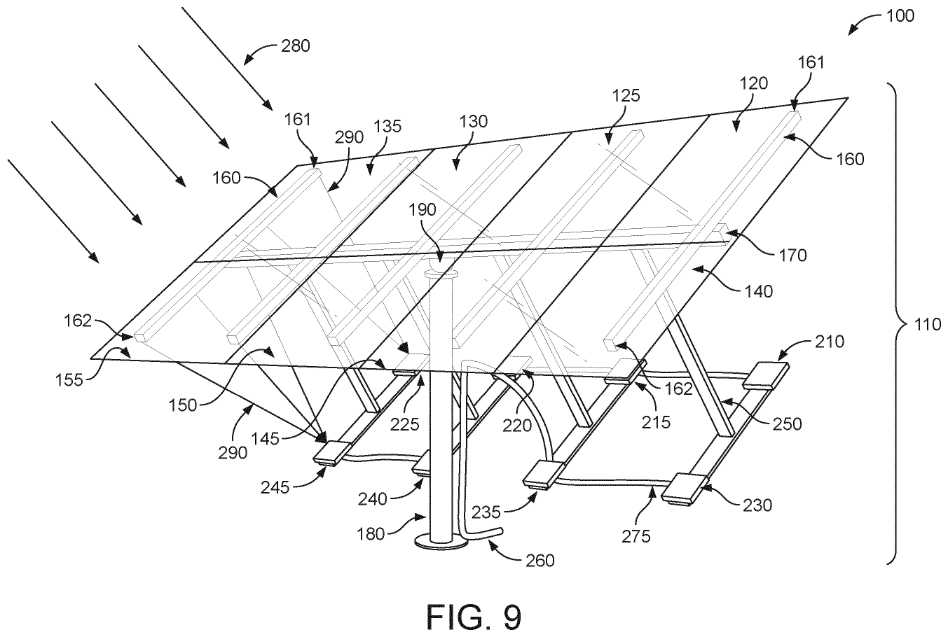

FIG. 9 shows an embodiment of the solar concentrator of the invention. Solar concentrator 100 comprises a support 110 for optical elements 120, 125, 130, 135, 140, 145, 150 and 155. Each optical element 120, 125, 130, 135, 140, 145, 150 and 155 is a planar rectangular light transmissive sheet capable of focusing electromagnetic radiation on to a receiver, or solar collector, 210, 215, 220, 225, 230, 235, 240, 245 respectively. The optical elements are as described above in relation to FIGS. 1 and 2, and are mounted on the support 110 such that the back surfaces of the optical elements are in contact with the support 110.

The support 110 comprises five supporting beams 160 each having the same length and a rectangular cross section, each extending in a mutually parallel direction with their longitudinal axes aligned and spaced at regular intervals, their distal ends 161 being aligned with one another and their proximal ends 162 being aligned with one another, such that the five supporting beams together define a rectangular plane, on the front face of which, that is, the face on which light is incident in use, are mounted the optical elements 120, 125, 130, 135, 140, 145, 150 and 155 in a planar rectangular arrangement, in this case a 2×4 array. The mounting is by means of clamps bearing on the support beams and the top surfaces of the optical elements, which are screwed together, with a rubber gasket between the clamp plate and the optical element to protect the glass substrate from the force exerted by the clamp. The supporting beams 160 are themselves supported from the back face of the rectangular plane defined by the supporting beams 160 and at the midpoints of their lengths by a mounting beam 170 having a rectangular cross section, which mounting beam is placed crosswise to the supporting beams and on which mounting beam the supporting beams are mounted at regular intervals by brackets on the mounting beam that are screwed to the supporting beams. Mounting beam 170 is itself supported on mounting post 180 whose upper end (as drawn) is movably attached to the longitudinal midpoint of mounting beam 170 by a swivel joint 190 permitting adjustment of the angle of the rectangular plane defined by the supporting beams 160 with respect to the surface on which mounting post 180 is mounted. The swivel joint 190 allows for tracking of the sun in two directions, height and azimuth. The lower end (as drawn) of the mounting post 180 is mounted on a surface on which it is desired to place the solar collector, for example on the ground or on a roof.

Also supported on mounting beam 170 are four receiver mounting supports 250. These each take the form of two rectangular cross-section beams joined to form a T-shape. Each receiver mounting support 250 functions to support two receivers 210 and 230, 215 and 235, 220 and 240, 225 and 245 such that each receiver is held in the focal area of the corresponding optical element 120 and 140, 125 and 145, 130 and 150, 135 and 155 respectively. Accordingly, each receiver is mounted at the two distal ends of the beam forming the transverse line of the T shape, by means of a bracket screwed to the beam and to the receiver. The third end of each of the T shaped receiver mounting supports 250 is joined to the mounting beam 170 such that the plane in which the receivers 210, 215, 220, 225, 230, 235, 240 and 245 are held is parallel to the plane formed by the array of the optical elements 120, 125, 130, 135, 140, 145, 150 and 155.

Each of the receivers 210, 215, 220, 225, 230, 235, 240 and 245 is a heat exchanger, which absorbs the focused sunlight to convert it to heat. A fluid circulates through the heat exchanger and is heated by the incident sunlight. The receivers are connected in series through conduits 275 that carry the circulating fluid through the heat exchangers to allow the fluid to be heated. The fluid is then carried through conduit connection point 260, which itself may be connected to a thermal storage, or to an apparatus requiring thermal power, such as a steam turbine, an absorption cooler or a thermal desalination apparatus.

In use, the swivel joint 190 is adjusted in order that the plane of the array of optical elements can receive incident sunlight 280 orthogonally to the plane of the array. The incident sunlight 280 is transmitted through the optical elements 120, 125, 130, 135, 140, 145, 150 and 155 and focused on to each of the receivers 210, 215, 220, 225, 230, 235, 240 and 245. Here, the focused sunlight 290 is converted into heat by the heat exchanger receivers, and the heat so generated is conveyed through conduits 275 to conduit connection point 260, from where it is conveyed to an apparatus requiring heat, or to suitable storage (not shown). The swivel joint may be provided with a solar tracker (not shown) that acts to maintain the plane of the array of optical elements orthogonal to the incident sunlight 280, or as nearly so as practically possible, in order to maximize the efficiency of collection of solar energy by the solar collector.

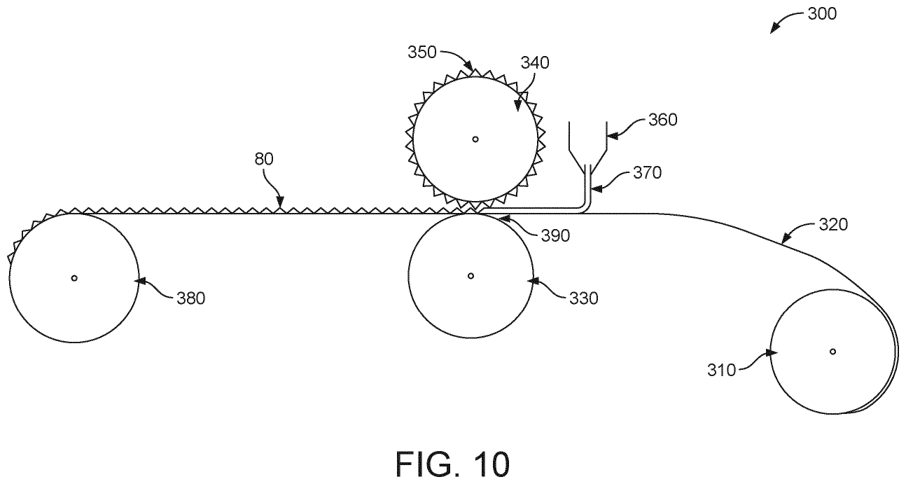

FIG. 10 depicts the manufacture of a mould, in the form of a microstructured thermoplastic film 80, for shaping a liquid silicone resin on the surface of a glass substrate. Manufacturing apparatus 300 comprises an unwind roller 310 on which a carrier foil 320 is wound, counter pressure roller 330 opposed to structured roller 340 coated with a metal master on which part-circular Fresnel lens microstructures 350 are made by single point diamond turning, nozzle 360 for delivering polymer melt 370 on to the surface of carrier film 320, and wind-up roller 380 on to which the microstructured thermoplastic film 80 is wound following its manufacture. The counter pressure roller 330 and structured roller 340 are positioned such as to form a nip 390 therebetween, through which the carrier foil 320 and polymer melt 370 pass.

In use, the carrier foil 320, such as a PET carrier foil, suitably having a thickness of 50 μm, is partially unwound from unwind roller 310, passed beneath nozzle 360 and through nip 390 between the counter pressure roller 330 and structured roller 340, and attached to the wind up roller 380. Beads or pellets of a thermoplastic polymer such as polypropylene are loaded into an extruder (not shown), and heated and extruded through nozzle 360 to form a polymer melt 370 which is formed as a layer, suitably of 60 μm thickness on carrier foil 320 upstream of nip 390. Simultaneously, carrier foil 320 is unwound from unwind roller 310 and wound onto wind up roller 380 such as to move the carrier foil 320 at a chosen speed through nip 390, and polymer melt 370 is extruded onto carrier foil 320 upstream of nip 390 at a chosen extrusion rate, such that the polymer melt 370 is supported on carrier foil 320 as it passes through nip 390. Passage of the polymer melt 370 through nip 390 results in the polymer melt being pressed against the microstructures 350 formed on the surface of structured roller 340 and adopting the form of the microstructures 350. In order to facilitate this structuring step, structured roller 340 and/or counter pressure roller 330 is maintained at a temperature below the solidification temperature of the polymer melt such that the polymer melt 370 is sufficiently fluid to adopt the form of the microstructures 350, but sufficiently viscous to maintain the form of the microstructures 350 once the melt has passed through nip 390 and is no longer in contact with the microstructures 350 of structured roller 340. Downstream of nip 390, the carrier foil 320 and microstructured polymer melt together form microstructured thermoplastic film 80. Suitably, active cooling means (not shown) may be provided downstream of nip 390 (ie in the direction of the wind-up roller 380) to speed the solidification of the microstructured polymer melt.

### EXAMPLES

### Example 1

A PET carrier foil having a thickness of 50 μm is wound from an unwind roller through a nip between a counterpressure roller and an extrusion coating roller having formed on the metal surface thereof part circular Fresnel lens microstructures, and is attached to a wind up roller. Beads of polypropylene are loaded into an extruder, heated until they are molten, and are extruded through the extruder nozzle on to the carrier foil upstream of the nip to form a layer of molten polypropylene of a thickness of 60 μm. The carrier foil and molten polypropylene layer then pass through the nip, in which the microstructured surface of the extrusion coating roller, which is maintained at a temperature lower than the solidification temperature of the polypropylene, contacts the molten polypropylene layer and causes it to adopt the form of the microstructures and to become solid, thus producing a mould in the form of a PET carrier foil supporting a microstructured solid polypropylene layer which is wound on to the wind up roller for storage until it is required.

When required, the mould is unwound from the wind up roller and is fed into a roll-to-plate lamination apparatus. A float glass substrate of 4 mm thickness and having GRIN nanostructures of 300 nm height and 0.75 aspect ratio on both surfaces is loaded into the roll-to-plate lamination apparatus. A nozzle is used to apply a series of drops of liquid PDMS silicone resin at a regular spacing on the upper surface of the glass substrate, such that a regular array of drops of liquid silicone resin is provided over the whole area of the upper surface of the substrate. The liquid silicone resin is not actively spread at this stage, though may spread to some extent as a result of its ability to wet the substrate and its surface tension. The mould is then applied to the substrate with the microstructured polypropylene layer facing the glass substrate having the liquid silicone resin drops thereon, starting at a first edge, and is pressed against the substrate by a roller to force the liquid silicone resin to spread and to adopt the form of the microstructures of the polypropylene layer of the mould. The roller moves along the mould from the first edge of the substrate to a second edge, thus causing it to unwind from the wind up roller and for successive parts of its length to be pressed against successive parts of the length of the substrate, until the mould entirely covers the upper face of the substrate and has been pressed against it such that a preliminary element comprising the glass substrate, a layer of liquid silicone resin and the mould arranged such that the mould and the upper face of the glass substrate are, on a macroscopic level, parallel to one another and the liquid silicone resin fully occupies the spaces between the microstructured polypropylene layer of the mould and the GRIN nanostructures of the upper face of the glass substrate. The mould is then cut at and parallel to the second edge of the substrate.

The preliminary element thus formed is then heated to cure and solidify the liquid silicone resin to provide an optical element in which a solid microstructured light-transmissive silicone coating lies between the upper surface of the glass substrate and the microstructured thermoplastic layer of the mould. The optical element is stored and transported in this form in order that the mould protects the microstructured silicone coating from abrasion and other damage.

When it is intended to install the optical element into a solar concentrator, the mould is peeled away from the microstructured silicone coating, and the optical element installed into its proper place in the solar concentrator. The mould can then be discarded.

### Example 2

A lens for use in a solar thermal concentrator is made as follows:

A glass substrate of dimensions 1500 mm×1500 mm×5 mm thickness, with antireflection gradient refractive index etching on each face, is placed on to a silicone rubber mat flat bed laminator. A two-component silicone, such as Sylgaard 184 from Dow Corning, is mixed in a 1:1 ratio, or as directed in the user manual, to form a liquid silicone resin mixture. This mixture is subjected to reduced pressure by means of vacuum pumping for around 10 min to remove dissolved air from the mixture. The degassed mixture is then distributed on to the upper face of the glass substrate in the laminator.

A polymer film having formed thereon structures that are the inverse of the geometric micro-Fresnel structures to be formed on the lens, and which film is slightly larger than the upper face of the glass substrate (ie of dimensions slightly larger than 1500 mm×1500 mm), is placed with its structured face in contact with the liquid silicone resin coated upper face of the glass substrate on the laminator. The roller of the flat bed laminator is then rolled over the polymer film on the glass substrate such as to apply pressure to remove air trapped between the polymer film and the glass substrate and to distribute the liquid silicone resin over the surface of the glass substrate to form a coating over the whole surface that is formed into the shape of the structures on the polymer film. The assembly of the substrate, formed liquid silicone resin coating and polymer film is then maintained at ambient temperature for 24 h to allow the formed liquid silicone resin coating to cure to form a structured silicone layer on the glass substrate. Once the silicone is cured, the polymer film is removed leaving the structured silicone layer on the glass, due to the superior adhesion between the anti-reflection gradient refractive index etched glass substrate and the silicone compared with that between the silicone and the polymer layer. A glass—silicone lens is thereby formed.

Whilst the invention has been described with reference to preferred embodiments, it will be appreciated that various modifications are possible within the scope of the invention.

In this specification, unless expressly otherwise indicated, the word ‘or’ is used in the sense of an operator that returns a true value when either or both of the stated conditions is met, as opposed to the operator ‘exclusive or’ which requires that only one of the conditions is met. The word ‘comprising’ is used in the sense of ‘including’ rather than in to mean ‘consisting of’. All prior teachings acknowledged herein are hereby incorporated by reference. No acknowledgement of any prior published document herein should be taken to be an admission or representation that the teaching thereof was common general knowledge in Australia or elsewhere at the date hereof.

1. A method of manufacture of an optical element for focusing electromagnetic radiation, comprising the steps of:
(a) providing a first light-transmissive glass substrate having a front surface on which the electromagnetic radiation is incident in use and a back surface opposite to the front surface;
(b) applying a liquid silicone resin to the back and/or the front surface of the glass substrate;
(c) contacting the liquid silicone resin with a mould such that the liquid silicone resin adopts the form of the mould and forms microstructures extending over the surface(s) of the glass substrate to which the liquid silicone resin has been applied;
(d) curing the liquid silicone resin to form a microstructured light-transmissive silicone coating;
wherein at least one of the surface(s) of the glass substrate to which the liquid silicone resin is to be applied is/are roughened, and
wherein, following step (a) and before step (b), the method further comprises the step of forming nanostructures on at least one of the surface(s) of the glass substrate to which the liquid silicone resin is to be applied, comprising etching a refractive index gradient structure on the surface(s) of the glass substrate to which the liquid silicone resin is to be applied, such that the nanostructures roughen the surface of the glass substrate and such that a porous structure is etched into the surface of the substrate, wherein the nanostructures have a height of 50 nm or more and a height of up to 400 nm.

2. The method according to claim 1, wherein the mould has a form that causes, in step (c), the liquid silicone resin to adopt the form of microstructures that focus the electromagnetic radiation incident on the optical element in use.

3. The method according to claim 1, wherein, the nanostructures have a height of up to 300 nm.

4. The method according to claim 1, wherein, in step (b), the application of the liquid silicone resin is carried out by application of one or more droplets, pools or areas of liquid silicone resin to the surface without any active spreading of the one or more droplets, pools or areas into a continuous layer during the application step (b).

5. The method according to claim 1, wherein, in step (c), the mould comprises a thermoplastic film, one surface of which has formed thereon microstructures that are the inverse of the microstructures that, when adopted by the liquid silicone resin, focus the electromagnetic radiation incident on the optical element in use.

6. The method according to claim 1, wherein, in step (c), the contacting of the liquid silicone resin with the mould comprises pressing the thermoplastic film surface on which the microstructures are formed against the liquid silicone resin in order that the liquid silicone resin adopts the form of the microstructures.

7. The method according to claim 1, wherein, in step (d), the curing is carried out using a combination of temperature and time.

8. The method according to claim 1, wherein, following the curing step (d), the mould is left in place on the cured light-transmissive silicone coating to act as a protective layer for the coating prior to its use as an optical element.

9. The method according to claim 1, wherein the method comprises the further step of:
(e) removing the mould from the microstructured light-transmissive silicone coating.

10. An optical element for focusing electromagnetic radiation, comprising:
a first light-transmissive glass substrate having a front surface on which the electromagnetic radiation is incident in use and a back surface opposite to the front surface; and
a light-transmissive silicone coating on the back and/or the front surface of the substrate;
wherein the silicone coating has formed thereon microstructures that focus the electromagnetic radiation incident on the optical element, and
wherein at least one of the surface(s) of the glass substrate on which the silicone coating is formed is/are roughened, wherein the roughened surface comprises a refractive index gradient structure etched on the glass substrate such that a porous structure is etched into the surface of the substrate; and
wherein the surface roughness of the surface(s) of the glass substrate on which the light-transmissive silicone coating is formed is in the form of nanostructures having a height of 50 nm or more up to 400 nm.

11. The optical element according to claim 10, wherein a protective film is provided on the side of the silicone coating that is not in contact with the glass substrate.

12. (canceled)

13. The optical element according to claim 10, wherein the surface roughness of the surface(s) of the glass substrate to which the liquid silicone resin is to be applied comprises nanostructures having a height of up to 300 nm, and/or wherein the surface roughness of the surface(s) of the glass substrate to which the liquid silicone resin is to be applied comprises nanostructures having a height of 100 nm or more.

14. The method according to claim 1, wherein the R_{z} value for the roughened surface is within the range of from 50 nm to 800 nm.

15. The method according to claim 1, wherein the glass substrate has a minimum front surface area of 0.25 m².

16. (canceled)

17. The optical element according to claim 10, wherein the optical element further comprises a second light transmissive glass substrate comprising a front face and a back face.

18. The optical element according to claim 17, wherein the second light transmissive glass substrate is not placed in contact with the first light transmissive glass substrate, or with the light transmissive silicone coating on the first light transmissive glass substrate.

19. The optical element according to claim 17, wherein the second light transmissive glass substrate has an antireflective coating on its front and/or the back face.

20. The optical element according to claim 17, wherein the second light transmissive glass substrate further comprises a light transmissive silicone coating having microstructures formed thereon on the front and/or the back face of the second light transmissive glass substrate, and wherein the face(s) of the second light transmissive glass substrate on which the light transmissive silicone coating are formed are roughened,
wherein the roughened surface comprises a refractive index gradient structure etched on the second light transmissive glass substrate such that a porous structure is etched into the surface of the substrate; and
wherein the surface roughness of the face(s) of the second light transmissive glass substrate on which the light-transmissive silicone coating is formed is in the form of nanostructures having a height of 50 nm or more up to 400 nm.

21. A solar concentrator comprising at least one optical element according to claim 10.

22. A method of manufacture of a solar concentrator, comprising the steps of:
i) providing one or more optical elements that focus solar radiation, the one or more optical elements comprising:
a first light-transmissive glass substrate having a front surface on which the electromagnetic radiation is incident in use and a back surface opposite to the front surface; and
a light-transmissive silicone coating on the back and/or the front surface of the substrate;
wherein the light-transmissive silicone coating has formed thereon microstructures that focus the solar radiation incident on the optical element in use,
wherein the surface(s) of the glass substrate on which the light-transmissive silicone coating is formed is/are roughened wherein the roughened surface comprises a refractive index gradient structure etched on the glass substrate such that a porous structure is etched into the surface of the substrate; and
wherein the surface roughness of the surface(s) of the glass substrate on which the light-transmissive silicone coating is formed is in the form of nanostructures having a height of 50 nm or more up to 400 nm;
ii) arranging the one or more optical elements to focus solar radiation to one or more focal areas;
iii) placing a collector of solar energy at the or each focal area.

23-25. (canceled)
